(19) United States
(12) Patent Application Publication
(10) Pub. No.: US 2022/0374341 A1
(43) Pub. Date: Nov. 24, 2022

(54) TECHNIQUES FOR DECOUPLED MANAGEMENT OF SOFTWARE TEST EXECUTION PLANNING AND CORRESPONDING SOFTWARE TEST EXECUTION RUNS

(71) Applicant: Infor (US), LLC, New York, NY (US)

(72) Inventor: Jeffrey Allen Brown, Colorado Springs, CO (US)

(21) Appl. No.: 17/328,888

(22) Filed: May 24, 2021

(51) Int. Cl. G06F 11/36

(52) U.S. Cl. CPC G06F 11/3684; G06F 11/3692; G06F 11/3688

(57) ABSTRACT

Various embodiments of the present invention provide methods, apparatuses, systems, computing devices, computing entities, and/or the like for executing efficient and reliable techniques for software test execution planning by utilizing at least one of static execution plan data entities, dynamic execution plan data entities, worksheet execution run data entities, automated execution run data entities, and manual execution run data entities.

### BACKGROUND

Various embodiments of the present invention address technical challenges related to software testing and make substantial technical improvements to improving the computational efficiency, traceability, and operational reliability of both test automation platforms and manual software testing platforms. Various embodiments of the present invention makes important technical contributions to the operational reliability of software applications that are tested using the software application platforms.

### BRIEF SUMMARY

In general, embodiments of the present invention provide methods, apparatuses, systems, computing devices, computing entities, and/or the like for executing efficient and reliable techniques for software test execution planning by utilizing at least one of static execution plan data entities, dynamic execution plan data entities, worksheet execution run data entities, automated execution run data entities, and manual execution run data entities.

In accordance with one aspect, a method is provided. In one embodiment, the method comprises: identifying a set of execution plan definition tags, wherein the set of execution plan definition tags comprise one or more included test case tags; determining, based at least in part on the set of execution plan definition tags, a planned test case subset of a set of candidate test case data entities, wherein (i) each candidate test case data entity is associated with a test case tag list, and (ii) each test case tag list for a candidate test case data entity that is in the planned test case subset comprises at least one included test case tag of the one or more included test case tags; generating the execution plan data entity based at least in part on the planned test case subset; and providing the execution plan for performing one or more software testing operations.

In accordance with another aspect, a computer program product is provided. The computer program product may comprise at least one computer-readable storage medium having computer-readable program code portions stored therein, the computer-readable program code portions comprising executable portions configured to: identify a set of execution plan definition tags, wherein the set of execution plan definition tags comprise one or more included test case tags; determine, based at least in part on the set of execution plan definition tags, a planned test case subset of a set of candidate test case data entities, wherein (i) each candidate test case data entity is associated with a test case tag list, and (ii) each test case tag list for a candidate test case data entity that is in the planned test case subset comprises at least one included test case tag of the one or more included test case tags; generate the execution plan data entity based at least in part on the planned test case subset; and provide the execution plan for performing one or more software testing operations.

In accordance with yet another aspect, an apparatus comprising at least one processor and at least one memory including computer program code is provided. In one embodiment, the at least one memory and the computer program code may be configured to, with the processor, cause the apparatus to: identify a set of execution plan definition tags, wherein the set of execution plan definition tags comprise one or more included test case tags; determine, based at least in part on the set of execution plan definition tags, a planned test case subset of a set of candidate test case data entities, wherein (i) each candidate test case data entity is associated with a test case tag list, and (ii) each test case tag list for a candidate test case data entity that is in the planned test case subset comprises at least one included test case tag of the one or more included test case tags; generate the execution plan data entity based at least in part on the planned test case subset; and provide the execution plan for performing one or more software testing operations.

In accordance with one aspect, a method is provided. In one embodiment, the method comprises: identifying a set of execution run definition parameters for the execution run data entity, wherein the set of execution run definition parameters comprise an execution run automation parameter for the execution run data entity; generating an executable test case subset of a set of candidate test case data entities for the execution run data entity, wherein the executable test case subset for the execution run data entity is determined by filtering a planned test case subset for the execution plan data entity based at least in part on the execution run automation parameter and a skipped test case list for the execution run data entity; generating the execution run data entity based at least in part on the executable test case subset and the set of execution run definition parameters; and enabling an end user to perform one or more software testing operations based at least in part on the execution run data entity.

In accordance with another aspect, a computer program product is provided. The computer program product may comprise at least one computer-readable storage medium having computer-readable program code portions stored therein, the computer-readable program code portions comprising executable portions configured to: identify a set of execution run definition parameters for the execution run data entity, wherein the set of execution run definition parameters comprise an execution run automation parameter for the execution run data entity; generate an executable test case subset of a set of candidate test case data entities for the execution run data entity, wherein the executable test case subset for the execution run data entity is determined by filtering a planned test case subset for the execution plan data entity based at least in part on the execution run automation parameter and a skipped test case list for the execution run data entity; generate the execution run data entity based at least in part on the executable test case subset and the set of execution run definition parameters; and enable an end user to perform one or more software testing operations based at least in part on the execution run data entity.

In accordance with yet another aspect, an apparatus comprising at least one processor and at least one memory including computer program code is provided. In one embodiment, the at least one memory and the computer program code may be configured to, with the processor, cause the apparatus to: identify a set of execution run definition parameters for the execution run data entity, wherein the set of execution run definition parameters comprise an execution run automation parameter for the execution run data entity; generate an executable test case subset of a set of candidate test case data entities for the execution run data entity, wherein the executable test case subset for the execution run data entity is determined by filtering a planned test case subset for the execution plan data entity based at least in part on the execution run automation parameter and a skipped test case list for the execution run data entity; generate the execution run data entity based at least in part on the executable test case subset and the set of execution run definition parameters; and enable an end user to perform one or more software testing operations based at least in part on the execution run data entity.

In accordance with one aspect, a method is provided. In one embodiment, the method comprises: identifying a planned test case subset of a set of candidate test case data entities for the previously-documented execution run data entity, wherein the execution result data entity comprises an execution result indicator for each candidate test case data entity in the planned test case subset; generating an eligible test case subset for the worksheet execution run data entity based at least in part on filtering the planned test case subset for the previously-documented execution run data entity, wherein filtering the planned test case subset is performed based at least in part on whether each execution result indicator for a candidate test case data entity in the planned test case subset is described by an execution result parameter for the worksheet execution run data entity; generating the worksheet execution run data entity based at least in part on an automation stage parameter value for each candidate test case data entity in the eligible test case subset; and enabling an end user to perform one or more software testing operations based at least in part on the worksheet execution run data entity.

In accordance with another aspect, a computer program product is provided. The computer program product may comprise at least one computer-readable storage medium having computer-readable program code portions stored therein, the computer-readable program code portions comprising executable portions configured to: identify a planned test case subset of a set of candidate test case data entities for the previously-documented execution run data entity, wherein the execution result data entity comprises an execution result indicator for each candidate test case data entity in the planned test case subset; generate an eligible test case subset for the worksheet execution run data entity based at least in part on filtering the planned test case subset for the previously-documented execution run data entity, wherein filtering the planned test case subset is performed based at least in part on whether each execution result indicator for a candidate test case data entity in the planned test case subset is described by an execution result parameter for the worksheet execution run data entity; generate the worksheet execution run data entity based at least in part on an automation stage parameter value for each candidate test case data entity in the eligible test case subset; and enable an end user to perform one or more software testing operations based at least in part on the worksheet execution run data entity.

In accordance with yet another aspect, an apparatus comprising at least one processor and at least one memory including computer program code is provided. In one embodiment, the at least one memory and the computer program code may be configured to, with the processor, cause the apparatus to: identify a planned test case subset of a set of candidate test case data entities for the previously-documented execution run data entity, wherein the execution result data entity comprises an execution result indicator for each candidate test case data entity in the planned test case subset; generate an eligible test case subset for the worksheet execution run data entity based at least in part on filtering the planned test case subset for the previously-documented execution run data entity, wherein filtering the planned test case subset is performed based at least in part on whether each execution result indicator for a candidate test case data entity in the planned test case subset is described by an execution result parameter for the worksheet execution run data entity; generate the worksheet execution run data entity based at least in part on an automation stage parameter value for each candidate test case data entity in the eligible test case subset; and enable an end user to perform one or more software testing operations based at least in part on the worksheet execution run data entity.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of a system that can be used to practice embodiments of the present invention;

FIG. 2A provides an example web server computing entity in accordance with some embodiments discussed herein;

FIG. 2B provides an example client computing entity in accordance with some embodiments discussed herein;

FIG. 3 is a flowchart diagram of an example process for executing (i.e., performing) a set of software testing operations in accordance with some embodiments discussed herein;

FIG. 4 is a flowchart diagram of an example process for dynamically generating an execution plan data entity based at least in part on a set of test case tags in accordance with some embodiments discussed herein;

FIG. 5 is a flowchart diagram of an example process for dynamically generating an execution plan data entity based at least in part on a set of element tags in accordance with some embodiments discussed herein;

FIG. 6 is a flowchart diagram of an example process for generating an execution plan data entity by statically updating a dynamic execution plan in accordance with some embodiments discussed herein;

FIG. 7 is a flowchart diagram of an example process for generating a worksheet execution run data entity based at least in part on a previously-documented execution run data entity in accordance with some embodiments discussed herein;

FIG. 8 is a flowchart diagram of an example process for generating an execution run data entity that is an automated execution run data entity in accordance with some embodiments discussed herein;

FIG. 9 is a flowchart diagram of an example process for generating an execution run data entity that is a manual execution run data entity in accordance with some embodiments discussed herein;

FIG. 10 is a flowchart diagram of an example process for generating a combined execution log for an execution run data entity that is an automated execution run data entity in accordance with some embodiments discussed herein;

FIG. 11 is a flowchart diagram of an example process for generating an execution log for an automated testing workflow data entity in accordance with some embodiments discussed herein;

FIG. 12 is a flowchart diagram of an example process for generating a modified execution run data entity and a session data entity for an execution run data entity that is a manual execution run data entity in accordance with some embodiments discussed herein;

FIGS. 13-17 provide an operational example of generating an execution plan data entity in accordance with some embodiments discussed herein;

FIGS. 18-23 and 28 provide an operational example of generating an execution run data entity in accordance with some embodiments discussed herein;

FIGS. 24A-24B and 25-27 provide an operational example of generating a worksheet execution run data entity in accordance with some embodiments discussed herein; and

FIGS. 29A-29D provide an operational example of approving an execution run data entity and cancelling an approved execution run data entity in accordance with some embodiments discussed herein.

### DETAILED DESCRIPTION

Various embodiments of the present invention are described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to execute other types of data analysis.

### Overview and Technical Advantages

Various embodiments of the present invention provide techniques for decoupling test execution plan management from test execution run management. For example, various embodiments of the present invention enable generating execution plan data entities based at least in part on a collection of test case data entities and generating execution run data entities based at least in part on all or a partial subset of the collection of test case data entities associated with execution plan data entities. In one exemplary embodiment, an execution planning data entity may be associated with test case data entities T1-T4, where T1-T2 are automatable test case data entities that are associated with automated testing workflow data entities, while T3-T4 are non-automatable test case data entities that are associated with automated testing workflow data entities. In this exemplary scenario, the execution plan data entity may be associated with two execution run data entities: a first, automated execution run data entity that is in turn associated with T1-T2, and a second, manual execution run data entity that is in turn associated with T1-T4.

Decoupling execution plan management from execution run management enables more targeted and more resilient software testing, as it enables a test planner to generate general instructions for testing that may be ignored/modified at runtime. In this way, decoupling execution plan management from execution run management gives an important degree of flexibility to execution run planners in integrating runtime limits/considerations when formulating how to approach software testing operations. The result is more resilient, more traceable, and more flexible software testing approaches that in turn leads to better software testing, which eliminates/reduces the need for repeat software testing operations through reducing the number of erroneous software testing operations.

In some embodiments, by reducing the number of erroneous testing operations by decoupling execution plan management from execution run management, various embodiments of the present invention improve the operational efficiency of test automation platforms by reducing the number of processing operations that need to be executed by the noted test automation platforms in order to enable software testing operations (e.g., automated software testing operations). By reducing the number of processing operations that need to be executed by the noted test automation platforms in order to execute software testing operations, various embodiments of the present invention make important technical contributions to the field of software application testing. Accordingly, by enhancing the accuracy and reliability of automated testing workflow data entities generated by software testing engineers, the user-friendly and intuitive automated testing workflow generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

Moreover, embodiments of the present invention address technical challenges associated with efficiently and effectively generating and visualizing software testing operations. Various existing software testing solutions are not user-friendly and require high technical software knowledge and intimate familiarity with the software being tested. Furthermore, various existing software testing solutions do not operate in visually intuitive forms. To address the noted efficiency and effectiveness challenges associated with various existing software testing solutions, various embodiments of the present disclosure describe software testing operations related to generating and/or modifying automated testing workflow data entities in a visual and user-friendly manner. Various embodiments of the present disclosure also utilize a multi-tenant cloud architecture allowing multiple clients to utilize the embodiments of the present disclosure and to share software testing operations between themselves, such as part of a Software-as-a-Service (SaaS) architecture. In doing so, various embodiments of the present invention address technical challenges associated with efficiency and reliability of various software testing solutions. In some embodiments, the multi-tenant cloud architecture enables sharing platform costs across multiple clients, thereby reducing costs of a test automation platform, which, in conventional test automation platforms, are very expensive. By allowing customers to share the burden of costs, various embodiments of the present invention reduces the overall cost for the parties who interact/utilize a test automation platform.

Various embodiments of the present invention improve traceability of software testing. By decoupling execution plans from execution runs, various embodiments of the present invention enable recording detailed information about what parts of an execution plan were executed during each run, what environments were the runs performed on, and what the results of those runs were. These information can on a granular level then be tied back to an execution plan. Decoupling execution plans from execution runs also enables skipping test cases during execution runs without harming the integrity of the execution plan. This in turn saves a lot of time for engineers involved in software testing by reducing the need for creating execution plans during each execution run. Decoupling execution planning from execution runs also reduces the need for execution managers to have intimate knowledge of test cases, thus enabling performing software testing in a distributed manner.

### Definitions of Certain Terms

The term “execution plan data entity” may refer to a data construct that is configured to describe a collection of test case data entities, a set of set of execution plan definition tags, and/or a set of test case data entity folders. For example, an execution plan data entity may describe a set of test case data entities that are generated based at least in part on a set of execution plan definition tags. In some embodiments, when an execution plan data entity is determined based at least in part on a set of test case data entities that are generated based at least in part on set of execution plan definition tags, the execution plan data entity may be referred to herein as a “dynamic execution plan data entity.” In some embodiments, a dynamic execution plan data entity describes a set of execution plan definition tags, and the set of execution plan definition tags are at the runtime of an execution run data entity for the dynamic execution plan data entity used to determine a collection of test case data entities. In some embodiments, a dynamic execution plan data entity describes a set of test case data entity folders, and the set of test case data entity folders are at the runtime of an execution run data entity for the dynamic execution plan data entity used to determine a collection of test case data entities. As another example, an execution plan data entity may describe a set of test case data entities that are explicitly selected by an end user of a web server computing entity. In some embodiments, when an execution plan data entity describes a set of test case data entities that are explicitly selected by an end user of a web server computing entity, the execution plan data entity may be referred to herein as a “static execution plan data entity.” Moreover, as described herein, the set of test case data entities described by an execution plan data entity may be referred to as the planned test case subset for the execution plan data entity. In some embodiments, execution plan data entities include worksheet execution run data entities that are generated based at least in part on previously-documented execution run data entities, as further described below.

The term “execution run data entity” may refer to a data construct that is configured to describe a defined execution of an execution plan data entity, such as a defined automated execution of an execution plan data entity or a defined manual execution of an execution plan data entity. In some embodiments, when an execution run data entity describes an automated execution of an execution plan data entity, the execution run data entity is referred to herein as an “automated execution run data entity.” In some embodiments, when an execution run data entity describes a manual execution of an execution plan data entity, the execution run data entity is referred to herein as a “manual execution run data entity.” In some embodiments, an execution run data entity is determined based at least in part on a set of execution run definition parameters for the execution run data entity, such as an execution run automation parameter for the execution run data entity that describes whether the execution run data entity is an automated execution run data entity or a manual execution run data entity; an execution run scheduling parameter for the execution run data entity that describes whether the execution run data entity should be executed once, periodically (e.g., in accordance with a defined periodicity), or in an on-demand manner as demanded by end users; an execution run parallelization parameter for the execution run data entity that describes whether the execution run data entity should be performed serially, sequentially, and/or in parallel; and an execution run web environment parameter for the execution run data entity that describes the Uniform Resource Locator (URL) for a base (i.e., starting) webpage of the execution run data entity.

The term “worksheet execution run data entity” may refer to a data construct that is configured to describe an execution run data entity that is generated based at least in part on filtering a planned test case subset for a previously-documented execution run data entity in accordance with an execution result data entity for the previously-documented execution run data entity and an execution result indicator for each candidate test case data entity in the planned test case subset. For example, in some embodiments, a worksheet execution run data entity may be generated by performing the following operations: (i) generating an eligible test case subset for the worksheet execution run data entity based at least in part on filtering the planned test case subset for the previously-documented execution run data entity, wherein filtering the planned test case subset is performed based at least in part on whether each execution result indicator for a candidate test case data entity in the planned test case subset is described by an execution result parameter for the previously-documented execution run data entity; and (ii) generating the worksheet execution run data entity based at least in part on an automation stage parameter value for each candidate test case data entity in the eligible test case subset. In some embodiments, a worksheet execution run data entity is stored by a web server computing entity in a storage platform associated with the web server computing entity only for a time period defined by an execution plan expiration parameter for the worksheet execution run data entity. In some embodiments, a worksheet execution run data entities can be associated with test case data entities that are not yet “ready for execution.” This may enable an automation engineer to test automation workflow data entities associated with an execution plan data entities before changing the status of the corresponding test case data entities from “ready for automation” to “ready for execution.” In some embodiments, the system will automatically update the automation stage parameter for a test case data entity to “ready for execution” upon a successful execution (e.g., test run) of the corresponding test case data entity within a worksheet execution run data entity. In some embodiments, test running worksheet execution run data entities enables running a group of test case data entities without creating execution plan data entities and/or without including the results of the test run among the execution result data for the executed test case data entities.

The term “previously-documented execution run data entity” may refer to a data construct that is configured to describe an execution run data entity that has been executed at least once before, such that each candidate test case data entity in a planned test case subset for the previously-documented execution run data entity is associated with an execution result indicator as described by an execution result data entity for the previously-documented run data entity. For example, the execution result data entity for a previously-documented execution run data entity may describe whether, for each candidate test case data entity in the planned test case subset for the previously-documented execution run data entity, the candidate test case data entity is associated with a set of features including one or more of the following: (i) a negative test case result indicator describing failure of the candidate test case data entity in a latest execution of previously-documented execution run data entity; (ii) a positive skipping indicator describing that the candidate test case data entity has been skipped by not executing the candidate test case data entity in a latest execution of previously-documented execution run data entity; (iii) an automation stage parameter value describing that the candidate test case data entity is not associated with an execution readiness value (i.e., is not ready for execution); (iv) a negative precondition passage indicator describing that the candidate test case data entity has failed or skipped its defined preconditions in a latest execution of previously-documented execution run data entity; (v) an affirmative auto-skipping indicator describing that the candidate test case data entity has been auto-skipped in a latest execution of previously-documented execution run data entity; (vii) an affirmative execution skipping indicator describing that the candidate test case data entity has been skipped in a latest execution of previously-documented execution run data entity; and (viii) a failure or skipping indicator describing that the candidate test case data entity has had either a negative test case result indicator or a positive skipping indicator in a latest execution of previously-documented execution run data entity.

The term “test case data entity” may refer to a data construct that is configured to describe data associated with a test case, where the test case may in turn describe a specification of the inputs, execution conditions, testing procedure, and expected results (e.g., including explicitly defined assertions as well as implicitly generated expected results such as the expected result that typing a value into a field causes the value to appear in the field) that define a test that is configured to be executed to achieve a particular software testing objective, such as to exercise a particular program path or to verify compliance with a specific operational requirement. In some embodiments, the test case data entity may be configured to describe test case data (e.g., webpage sequence data, user interaction sequence data, application programming interface (API) call sequence data, and/or the like) associated with a corresponding test case. In some embodiments, a test case data entity is configured to describe: (i) one or more test case page images associated with the test case, and (ii) for each test case page image of the one or more test case page images, a set of test case steps that relate to the test case page image.

The term “test case page image” may refer to a data construct that is configured to describe an image associated with a state of a webpage that is visited during a test. For example, in some embodiments, a test case page image may depict a webpage image that is determined based at least in part on a session data entity associated with the test case data entity (as further described below). As another example, in some embodiments, a test case page image may depict a user-uploaded and/or user-selected image that is configured to depict a state of a webpage associated with a corresponding test case data entity. In some embodiments, each visited webpage associated with a test case data entity may be associated with more than one test case page image, where each test case page image may depict a different state of the visited webpage. For example, consider a webpage that includes a dropdown menu interactive page element. In the noted example, some test case page images associated with the webpage may depict a visual state of the webpage in which the dropdown menu interactive page element is in a non-expanded state, while other test case page images associated with the webpage may depict a visual state of the webpage in which the dropdown menu interactive page element is in an expanded state. As another example, consider a webpage that is configured to generate a transitory notification (e.g., a transitory notification that is generated in response to a defined user action, such as in response to the user hovering over an interactive page element and/or in response to the user selecting an interactive button). In the noted example, some test case page images associated with the webpage may depict a visual state of the webpage in which the transitory notifications are displayed, while other test case page images associated with the webpage may depict a visual state of the webpage in which the transitory notifications are not displayed.

The term “test case step” may refer to a data construct that is configured to describe a user action required by a test associated with a corresponding test case data entity, where the user action may be performed with respect to an interactive page element of a webpage associated with a test case page image of the corresponding test case data entity. In some embodiments, a test case step may be associated with test case data used to generate at least one of the following: (i) a visual element identifier overlaid on the test case page image in an overlay location associated with a region of the test case page image that corresponds to the interactive page element for the test case step (e.g., is defined in relation to the interactive page element, for example is placed at the upper left of the interactive page element); and (ii) a test case step action feature that describes one or more action features of the user action associated with the test case step. For example, if a test case step corresponds to the user action of selecting a particular button on a particular webpage, the test case step may describe data corresponding to a visual element identifier overlaid on an image region of a test case page image for the particular webpage that corresponds to (e.g., is defined in relation to) a location of the particular button on the particular webpage. In the noted example, the test case step may describe data associated with action features of a user action that may be used to generate a test case step action feature. An action feature of a user action may describe any property of a user action that is configured to change a state and/or a value of an interactive page element within a webpage. Examples of action features for a user action include (i) a user action type of the user action that may describe a general input mode of user interaction with the interactive page element associated with the user action; (ii) a user input value of the user action that may describe a value provided by the user to an interactive page element; (iii) a user action sequence identifier of the user action that may describe a temporal order of the user action within a set of sequential user actions performed with respect to interactive page elements of a webpage associated with the user action; and (iv) a user action time of the user action that may describe a captured time of the corresponding user action, and/or the like.

The term “test case tag list” may refer to a data construct that is configured to describe a set of user-defined labels for the entirety of a test case data entity, such as a tag that is assigned to the test case data entity when an end user interacts with a test case visualization user interface associated with the test case data entity. In some embodiments, if a candidate test case data entity is not associated with any user-defined labels for the entirety of the test case data entity, then the test case tag list for the candidate test case data entity may be empty. While various embodiments of the present invention describe categorizing test case data entities using test case tags, a person of ordinary skill in the relevant technology will recognize that any other methods for categorization of test case data entities (e.g., using folders to categorize test case data entities) may be used to generate static execution plan data entities.

The term “element tag list” may refer to a data construct that is configured to describe a set of user-defined labels for a set of interactive page elements that are associated with a set of test case steps of the test case data entity. As described above, a test case data entity may be associated with a set of test case steps, where each test case step may in turn be associated with an interactive page element of a webpage that is associated with a test case page image for the test case data entity. In some embodiments, a web server computing entity may enable an end user to define labels for particular interactive page elements of particular test case steps of a test case data entity, and these defined labels may be aggregated to generate the element tag list for the test case data entity. For example, consider a test case step that is associated with two webpages W1 and W2, where the test case page image for W1 is in turn associated with a test case step S1 for an interactive page element E1 having a user-defined element label L1, and a test case step S2 for an interactive page element E2 that does not have a user-defined element label, while the test case page image for W2 is in turn associated with a test case step S3 for an interactive page element E3 having a user-defined element label L3, and a test case step S4 for an interactive page element E4 that does not have a user-defined element label. In the noted exemplary scenario, the element tag list for the exemplary test case data entity comprises L1 and L3. In some embodiments, if a candidate test case data entity is not associated with any user-defined element labels for any of its corresponding interactive page elements, then the element tag list for the candidate test case data entity may be empty.

The term “set of test case tag associations” may refer to a data construct that is configured to describe at least one of the following: (i) a set of included test case tags for a corresponding execution plan data entity, such that if a candidate test case data entity in a set of candidate test case data entities includes at least one of the set of included test case tags, then the candidate test case data entity should be added to a set of test case data entities described by the corresponding execution plan data entity; and (ii) a set of excluded test case tags for a corresponding execution plan data entity, such that if a candidate test case data entity in a set of candidate test case data entities includes any one or more of the set of excluded test case tags, then the candidate test case data entity should be excluded from a set of test case data entities described by the corresponding execution plan data entity even if the candidate test case data entity is associated with at least one of the included test case tags.

The term “set of element tag associations” may refer to a data construct that is configured to describe at least one of the following: (i) a set of included element tags for a corresponding execution plan data entity, such that if the element tag list for a candidate test case data entity in a set of candidate test case data entities includes at least one of the set of included element tags, then the candidate test case data entity should be added to a set of test case data entities described by the corresponding execution plan data entity; and (ii) a set of excluded element tags for a corresponding execution plan data entity, such that a candidate test case data entity in a set of candidate test case data entities includes any one or more of the set of excluded element tags, then the candidate test case data entity should be excluded from a set of test case data entities described by the corresponding execution plan data entity even if the candidate test case data entity is associated with at least one of the included element tags.

The term “execution result data entity” may refer to a data construct that is configured to describe an execution result indicator for each candidate test case data entity in the planned test case subset for a corresponding previously-documented execution run data entity. For example, the execution result data entity for a previously-documented execution run data entity may describe whether, for each candidate test case data entity in the planned test case subset for the previously-documented execution run data entity, the candidate test case data entity is associated with one or more of the following: (i) a negative test case result indicator describing failure of the candidate test case data entity in a latest execution of previously-documented execution run data entity; (ii) a positive skipping indicator describing that the candidate test case data entity has been skipped in a latest execution of previously-documented execution run data entity; (iii) an automation stage parameter value describing that the candidate test case data entity is not associated with an execution readiness value (i.e., is not ready for execution); (iv) a negative precondition passage indicator describing that the candidate test case data entity has failed or skipped its defined preconditions in a latest execution of previously-documented execution run data entity; (v) an affirmative auto-skipping indicator describing that the candidate test case data entity has been auto-skipped in a latest execution of previously-documented execution run data entity; (vii) an affirmative execution skipping indicator describing that the candidate test case data entity has been skipped in a latest execution of previously-documented execution run data entity; and (viii) a failure or skipping indicator describing that the candidate test case data entity has had either a negative test case result indicator or a positive skipping indicator in a latest execution of previously-documented execution run data entity.

The term “execution result indicator” may refer to a data construct that is configured to describe which execution result states are associated with a corresponding candidate test case data entity. For example, the execution result indicator for a candidate test case data entity that is in the planned test case subset for a previously-documented execution run data entity may describe whether the candidate test case data entity is associated with one or more of the following: (i) a negative test case result indicator describing failure of the candidate test case data entity in a latest execution of previously-documented execution run data entity; (ii) a positive skipping indicator describing that the candidate test case data entity has been skipped in a latest execution of previously-documented execution run data entity; (iii) an automation stage parameter value describing that the candidate test case data entity is not associated with an execution readiness value (i.e., is not ready for execution); (iv) a negative precondition passage indicator describing that the candidate test case data entity has failed or skipped its defined preconditions in a latest execution of previously-documented execution run data entity; (v) an affirmative auto-skipping indicator describing that the candidate test case data entity has been auto-skipped in a latest execution of previously-documented execution run data entity; (vii) an affirmative execution skipping indicator describing that the candidate test case data entity has been skipped in a latest execution of previously-documented execution run data entity; and (viii) a failure or skipping indicator describing that the candidate test case data entity has had either a negative test case result indicator or a positive skipping indicator in a latest execution of previously-documented execution run data entity. In this example, (i)-(viii) are examples of execution result states, one or more of which may be specified by the execution result indicator for a particular candidate test case data entity.

The term “eligible test case subset” may refer to a data construct that is configured to describe each candidate test case data entity in a planned test case subset for a previously-documented execution run data entity associated with the worksheet execution run data entity that is also associated with an execution result indicator described by the execution result parameter for the worksheet execution run data entity. In some embodiments, if the execution result indicator for a candidate test case data entity in the planned test case subset for a previously-documented execution run data entity describes that the execution result indicator corresponds to an execution result parameter for a worksheet execution run data entity, then the candidate test case data entity is included among the eligible test case subset for the worksheet execution run data entity. For example, if the execution result parameter for a worksheet execution run data entity describes requiring either of execution result states that are associated with a negative test case result indicator and a positive skipping indicator, then a candidate test case data entity is included in the eligible test case subset for the worksheet execution run data entity if the execution result indicator for the candidate test case data entity describes at least one of an execution result state that is associated with a negative test case result indicator and an execution result state that is associated with a positive skipping indicator.

The term “execution result parameter” may refer to a data construct that is configured to describe desired/selected execution result states for execution result indicators of candidate test case data entities that are included in the eligible test case subset for the worksheet execution run data entity. For example, the execution result parameter for a worksheet execution run data entity may describe requiring either of execution result states that are associated with a negative test case result indicator and a positive skipping indicator to be included in the eligible test case subset for the worksheet execution run data entity. As another example, the execution result parameter for a worksheet execution run data entity may describe requiring both of execution result states that are associated with a negative test case result indicator and a positive skipping indicator to be included in the eligible test case subset for the worksheet execution run data entity.

The term “execution run definition parameter” may refer to a data construct that is configured to describe a property related to execution of an execution plan data entity as described by the corresponding execution run data entity for the execution data entity. Examples of execution run definition parameters include an execution run automation parameter for the execution run data entity that describes whether the execution run data entity is an automated execution run data entity or a manual execution run data entity; an execution run scheduling parameter for the execution run data entity that describes whether the execution run data entity should be executed once, periodically (e.g., in accordance with a defined periodicity), or in an on-demand manner as demanded by end users; an execution run parallelization parameter for the execution run data entity that describes whether the execution run data entity should be executed sequentially or in parallel; an execution run serial execution parameter for the execution run data entity that describes whether the execution run data entity should be executed serially or concurrently; and an execution run web environment parameter for the execution run data entity that describes the Uniform Resource Locator (URL) for a base (i.e., starting) webpage of the execution run data entity.

The term “automatable test case subset” may refer to a data construct that is configured to describe each candidate test case data entity that both is in the planned test case subset for an execution plan data entity associated with the execution run data entity and is associated with an automated testing workflow data entity. In other words, the automatable test case subset for an execution run data entity includes each candidate test case data entity that is in the planned test case subset and that is additionally automatable.

The term “automated testing workflow data entity” may refer to a data construct that is configured to describe a sequence of web-based actions that may be executed to generate an automated testing operation associated with a software test that is configured to be executed to achieve a particular software testing objective, such as to exercise a particular program path or to verify compliance with a specific operational requirement. For example, the automated testing workflow data entity may describe a sequence of webpages associated with a software testing operation, where each webpage may in turn be associated with a set of automated testing workflow steps. The sequence of webpages and their associated automated testing workflow steps may then be used to generate automation scripts for the software testing operation, where the automation script may be executed by an execution agent in order to execute the software testing operation and generate a software testing output based at least in part on a result of the execution of the automation script. In some embodiments, an automated testing workflow data entity is determined based at least in part on a test case data entity for the corresponding software testing operation, where the test case data entity may describe data associated with a test case, where the test case may in turn describe a specification of the inputs, execution conditions, testing procedure, and expected results that define a test that is configured to be executed to achieve a particular software testing objective, such as to exercise a particular program path or to verify compliance with a specific operational requirement.

The term “automated testing workflow step” may refer to a data construct that is configured to describe a user action required by a software testing operation associated with a corresponding automated testing workflow data entity, where the user action may be executed with respect to an interactive page element of a webpage associated with a captured page image of the corresponding automated testing workflow data entity. In some embodiments, an automated testing workflow step may be associated with: (i) an image region of the corresponding captured page image that corresponds to the interactive page element for the automated testing workflow step; and (ii) a workflow step action feature element that describes one or more action features of the user action associated with the automated testing workflow step. For example, if an automated testing workflow step corresponds to the user action of selecting a particular button on a particular webpage, the automated testing workflow step may describe data corresponding to an image region of a captured image for the particular webpage that corresponds to (e.g., is defined in relation to) a location of the particular button on the particular webpage. In the noted example, the automated testing workflow step may describe data associated with action features of a user action that may be used to generate a workflow step action feature element for the automated testing workflow step. An action feature of a user action may describe any property of a user action that is configured to change a state and/or a value of an interactive page element within a webpage. Examples of action features for a user action include: (i) a user action type of the user action that may describe a general input mode of user interaction with the interactive page element associated with the user action; (ii) a user input value of the user action that may describe a value provided by the user to an interactive page element; (iii) a user action sequence identifier of the user action that may describe a temporal order of the user action within a set of sequential user actions executed with respect to interactive page elements of a webpage associated with the user action; and (iv) a user action time of the user action that may describe a captured time of the corresponding user action, and/or the like.

The term “executable test case subset” may refer to a data construct that is configured to describe a set of candidate test case data entities that are defined to be executed during an execution of the execution run data entity. In some embodiments, if the execution run data entity is an automated execution run data entity, the executable test case subset for the execution run data entity comprises each test case data entity in the automatable test case subset for the execution run data entity that is not in a skipped test case list for the execution run data entity (e.g., a user-defined skipped test case list for the execution run data entity that may in some embodiments be empty if the user has not specified any test case data entities from the automatable test case subset to skip in order to generate the executable test case subset). In some embodiments, if the execution run data entity is an automated execution run data entity, the executable test case subset for the execution run data entity comprises each test case data entity in the planned test case subset for the test case plan data entity associated with the execution run data entity that is in a skipped test case list for the execution run data entity (e.g., a user-defined skipped test case list for the execution run data entity that may in some embodiments be empty if the user has not specified any test case data entities from the planned test case subset to skip in order to generate the executable test case subset). In some embodiments, generating the executable test case subset comprises, in response to determining that the execution run automation parameter describes that the execution run data entity has an automated execution run automation type, generating an automatable test case subset of the planned test case subset, wherein each candidate test case data entity in the automatable test case subset is associated with an automated testing workflow data entity, and filtering the automatable test case subset based at least in part on the skipped test case list to generate the executable test case subset. In some embodiments, generating the executable test case subset comprises, in response to determining that the execution run automation parameter describes that the execution run data entity has a manual execution run automation type, filtering the planned test case subset based at least in part on the skipped test case list to generate the executable test case sub set.

The term “workflow playback operation” may refer to a data construct that is configured to describe an operation that is configured to perform a captured user action associated with a corresponding automated testing workflow step within a web environment of the automated testing workflow data entity that comprises the corresponding automated testing workflow step. In some embodiments, executing a workflow playback operation comprises: (i) identifying a workflow simulation web environment for a webpage associated with the automated testing workflow step for the workflow playback operation; (ii) generating a modified web environment state for the automated testing workflow step by modifying a web environment state of the workflow simulation web environment based at least in part on a captured user interaction for the automated testing workflow step; and (iii) generating the success indicator for the workflow playback operation based at least in part on the modified web environment state for the automated testing workflow step.

The term “session data entity” may refer to a data construct that is configured to describe recorded/captured data associated with a set of user interactions in relation to a set of webpages. For example, the session data entity may describe that an end user loads a first webpage, enters a text input in a first designated textbox on the first webpage, selects a first designated checkbox on the first webpage, selects a first designated button on the first webpage to proceed to a second webpage, selects a set of items from a first designated list box on the second webpage, selects a first designated radio button from a first designated set of related radio buttons on the second webpage, and selects a second designated button on the second webpage. In the noted example, a software component (e.g., a web browser extension) may be configured to detect and record a set of user interactions by an end user across the two webpages in order to generate the session data entity. Thus, the session data entity may describe: (i) a sequence of webpages across which user interactions have been captured; and (ii) for each webpage of the sequence of webpages, a set of user interactions performed in relation to the noted webpage. For example, for the exemplary session data entity described above, the session data entity may describe: (i) a sequence of webpages that describes that the first webpage was visited first and the second webpage was subsequently visited; (ii) for the first webpage, the user interactions corresponding to entering a text input in the first designated textbox on the first webpage, selecting the first designated checkbox on the first webpage, and selecting the first designated button on the first webpage; and (iii) for the second webpage, the user interactions corresponding to selecting the first designated radio button from the first designated set of related radio buttons on the second webpage and selecting the second designated button on the second webpage. In some embodiments, the session data entity comprises (a) an ordered sequence of a plurality of captured page images that (i) were captured during the session, and (ii) correspond to a plurality of webpages visited by the end user during the session, and (b) a plurality of captured user interactions performed by the end user while interacting with the plurality of webpages.

The term “captured page image” may refer to a data construct that is configured to describe an image file that depicts a screenshot of a corresponding webpage at a particular point in time during a captured sequence of user interactions with the corresponding webpage, where the captured sequence of user interactions may be described by a session data entity that comprises the captured webpage. In some embodiments, prior to loading a subsequent webpage after a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage after all of the corresponding user interactions associated with the current webpage are performed. In some embodiments, immediately subsequent to successfully loading a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage before all of the corresponding user interactions associated with the current webpage are performed.

The term “captured user interaction” may refer to a data construct that is configured to describe a recorded/captured user action with respect to a segment of a webpage, where the captured user interaction may be described by a session data entity corresponding to a recorded/captured session that included performing the corresponding user action associated with the captured user interaction. In some embodiments, a captured user interaction describes: (i) an associated interactive page element within a corresponding webpage with respect to which the corresponding user action was performed during the recorded/captured session; (ii) a user action type of the corresponding user action with respect to the associated interactive page element within the corresponding webpage; and (iii) if the corresponding user action type of the corresponding user action requires inputting a user input value, the user input value entered as part of the corresponding user action associated with the captured user interaction. For example, consider a recorded/captured session that included the user action of selecting a button within a webpage. In the noted example, the captured user interaction corresponding to the noted action may describe: (i) the button as the interactive page element corresponding to the captured user interaction; and (ii) (i.e., clicking) as the user action type of the captured user interaction.

### Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage median include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of an apparatus, system, computing device, computing entity, and/or the like executing instructions stored on a computer-readable storage medium to execute certain steps or operations. Thus, embodiments of the present invention may also take the form of an entirely hardware embodiment, an entirely computer program product embodiment, and/or an embodiment that comprises combination of computer program products and hardware executing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be executed sequentially such that one instruction is retrieved, loaded, and executed at a time. In some exemplary embodiments, retrieval, loading, and/or execution may be executed in parallel such that multiple instructions are retrieved, loaded, and/or executed together. Thus, such embodiments can produce specifically-configured machines executing the steps or operations specified in the block diagrams and flowchart illustrations. Accordingly, the block diagrams and flowchart illustrations support various combinations of embodiments for executing the specified instructions, operations, or steps.

### Exemplary System Framework

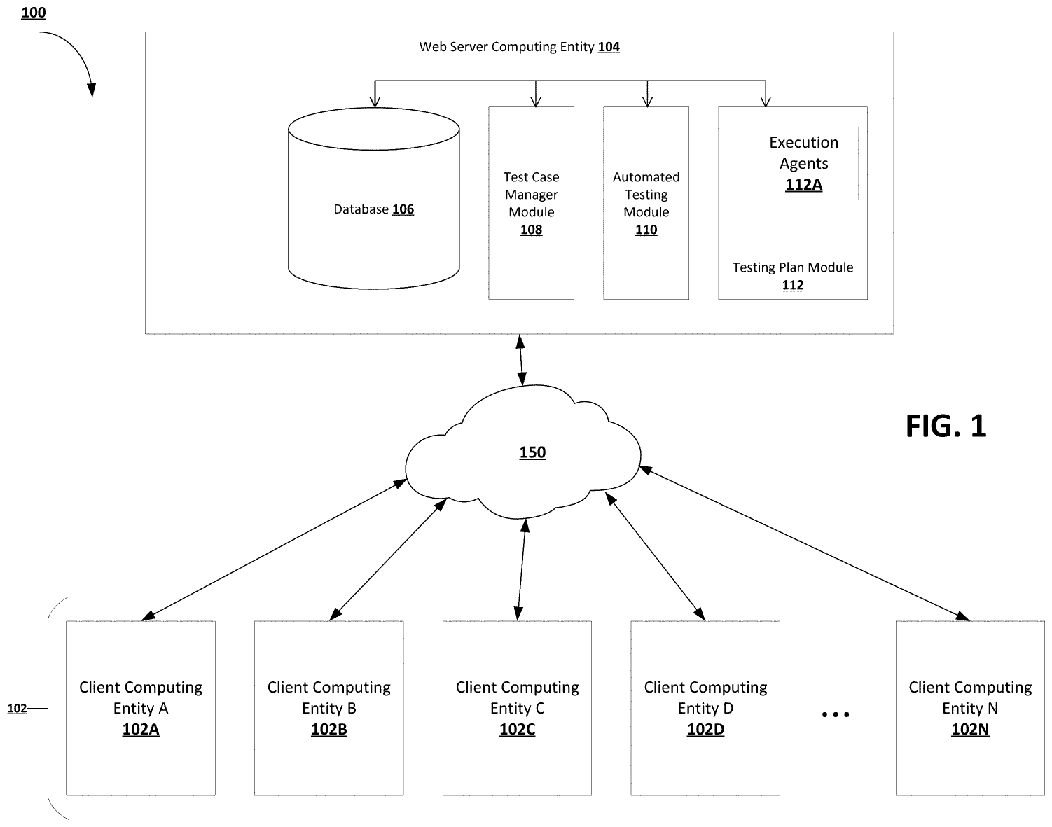

FIG. 1 is a schematic diagram of an example system architecture 100 for visually documenting a software testing operation, generating an automated testing workflow data entity, and performing a set of software testing operations. The system architecture 100 comprises a plurality of client computing entities 102 and a multi-tenant cloud architecture characterized by a web server computing entity 104, where the web server computing entity 104 comprises a database 106, a test case manager module 108, an automated testing module 110, and a testing plan module 112.

In some embodiments, the web server computing entity 104 may be made available as a “Software-as-a-Service” framework to multiple end users through the multi-tenant cloud architecture. In some embodiments, the multiple end users may each use a client computing entities 102A-N to connect (through the web server computing entity 104) to the multi-tenant cloud architecture to cause execution of one or more software testing operations associated with the web server computing entity 104. The web server computing entity 104 may enable communication between client computing entities 102A-N via one or more communication networks 150. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The web server computing entity 104 may be configured to enable generating visual documentation for a software testing operation and executing the software testing operation based at least in part on the visual documentation. The visual documentation for a software testing operation may be referred to as a “test case data entity” herein. The web server computing entity 104 may be configured to enable modifying test case data entities, integrating test case data entities across test case libraries, manually executing test case data entities, automatically executing automation scripts corresponding to test case data entities, and/or the like.

The web server computing entity 104 may further be configured to generate sequences of automatable web-based actions that may be executed in order to automatically execute software testing operations. Such defined sequences of automatable web-based actions may be referred to as “automated testing workflow data entities” herein. The web server computing entity 104 may be configured to enable modifying automated testing workflow data entities, integrating automated testing workflow data entity into other automated testing workflow data entities, automatically execution automation scripts corresponding to the automated testing workflow data entities, and/or the like.

The web server computing entity 104 may further be configured to generate automation scripts for automated testing workflow data entities. Such automation scripts are referred to as “execution plan data entities” herein. The web server computing entity 104 may be configured to enable modifying execution plan data entities, executing corresponding sequences of web-based actions in accordance with execution plan data entities, generating execution run data entities based at least in part on the execution plan data entities, executing the noted execution run data entities, and/or the like.

The web server computing entity 104 may comprise a test case manager module 108, an automated testing module 110, and a testing plan module 112. The test case manager module 108 may be configured to enable generating test case data entities, modifying test case data entities, integrating test case data entities across test case libraries, manually executing test case data entities, automatically executing automation scripts corresponding to test case data entities, and/or the like.

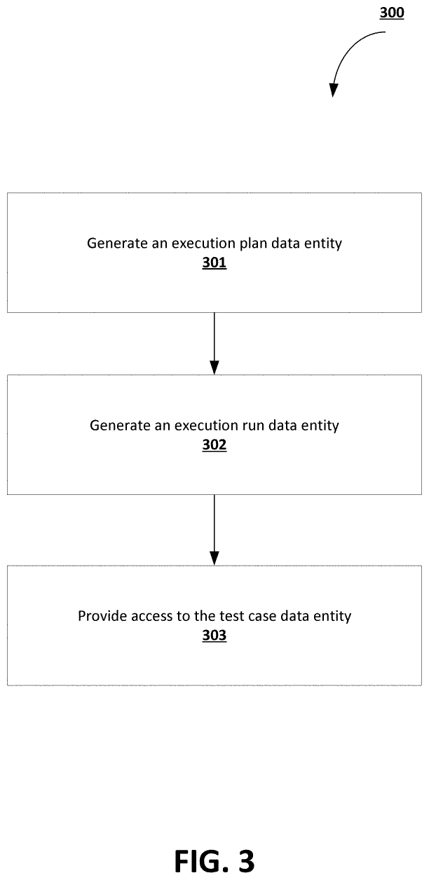

The automated testing module may be configured to enable generating automated testing workflow data entities, modifying automated testing workflow data entities, integrating automated testing workflow data entity into other automated testing workflow data entities, automatically execution automation scripts corresponding to the automated testing workflow data entities, and/or the like. An operational example of an automated testing module 110 is depicted in FIG. 3.

The testing plan module 112 may be configured to enable generating execution plan data entities, generating execution run data entities, and executing the execution run data entities. The testing plan module 112 comprises a set of execution agents 112A that are configured to execute the execution run data entities, e.g., execute corresponding sequence of web-based actions defined by automated testing workflow data entities in accordance with the automation scripts for the noted automated testing workflow data entities as defined by the execution plan data entities for the noted automated testing plan data entities.

The database 106 may include one or more storage units, such as multiple distributed storage units that are connected through a computer network. The database 106 may store data using one or more non-volatile storage or memory median, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Web Server Computing Entity

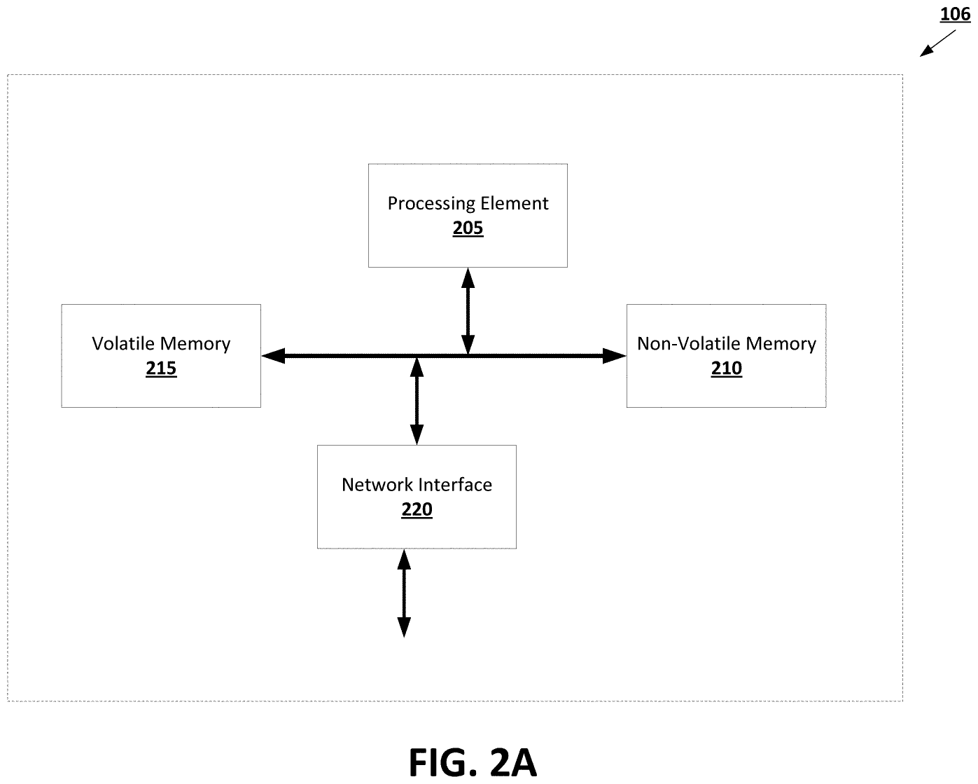

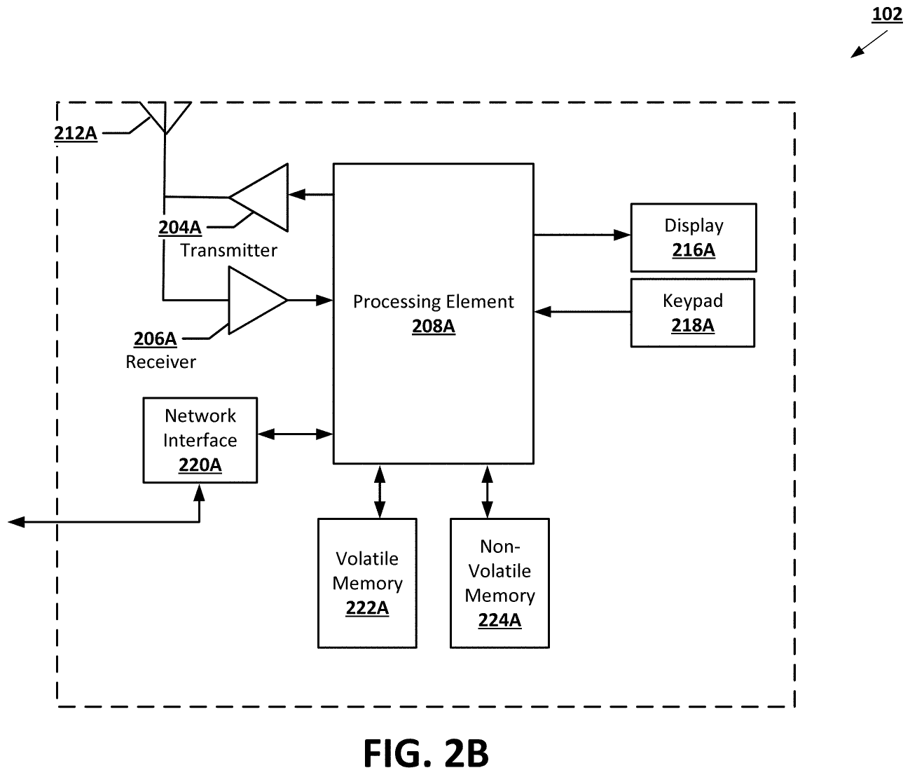

FIG. 2A provides a schematic of a web server computing entity 104 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to execute the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be executed on data, content, information, and/or similar terms used herein interchangeably.

As indicated, in one embodiment, the web server computing entity 104 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the web server computing entity 104 may include, or be in communication with, one or more processing elements 205 (also referred to as processors, processing circuitry, and/or similar terms used herein interchangeably) that communicate with other elements within the web server computing entity 104 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of executing steps or operations according to embodiments of the present invention when configured accordingly.

In one embodiment, the web server computing entity 104 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the web server computing entity 104 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the web server computing entity 104 with the assistance of the processing element 205 and operating system.

As indicated, in one embodiment, the web server computing entity 104 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the web server computing entity 104 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the web server computing entity 104 may include, or be in communication with, one or more input elements, such as a keyboard input, a mouse input, a touch screen/display input, motion input, movement input, audio input, pointing device input, joystick input, keypad input, and/or the like. The web server computing entity 104 may also include, or be in communication with, one or more output elements (not shown), such as audio output, video output, screen/display output, motion output, movement output, and/or the like.

### Exemplary Client Computing Entity

FIG. 2B provides an illustrative schematic representative of a client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to execute the functions, operations, and/or processes described herein. Client computing entities 102 can be operated by various parties. As shown in FIG. 3, the client computing entity 102 can include an antenna 212A, a transmitter 204A (e.g., radio), a receiver 206A (e.g., radio), and a processing element 208A (e.g., CPLDs, microprocessors, multi-core processors, coprocessing entities, ASIPs, microcontrollers, and/or controllers) that provides signals to and receives signals from the transmitter 204A and receiver 206A, correspondingly.

The signals provided to and received from the transmitter 204A and the receiver 206A, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the web server computing entity 104. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the web server computing entity 104 via a network interface 220A.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 216A coupled to a processing element 208A) and/or a user input interface (coupled to a processing element 208A). For example, the user interface may be a user application, browser, user interface, and/or similar words used herein interchangeably executing on and/or accessible via the client computing entity 102 to interact with and/or cause display of information/data from the web server computing entity 104, as described herein. The user input interface can comprise any of a number of devices or interfaces allowing the client computing entity 102 to receive data, such as a keypad 218A (hard or soft), a touch display, voice/speech or motion interfaces, or other input device. In embodiments including a keypad 218A, the keypad 218A can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 222A and/or non-volatile storage or memory 224A, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the web server computing entity 104 and/or various other computing entities.

In another embodiment, the client computing entity 102 may include one or more components or functionality that are the same or similar to those of the web server computing entity 104, as described in greater detail above. As will be recognized, these architectures and descriptions are provided for exemplary purposes only and are not limited to the various embodiments.

In various embodiments, the client computing entity 102 may be embodied as an artificial intelligence (AI) computing entity, such as an Amazon Echo, Amazon Echo Dot, Amazon Show, Google Local, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Exemplary System Operations

Various embodiments of the present invention enable techniques for decoupling test execution plan management from testing execution run management. Decoupling execution plan management from execution run management enables more targeted and more resilient software testing, as it enables a test planner in generating general instructions for testing that may be ignored/modified at runtime. In this way, decoupling execution plan management from execution run management gives an important degree of flexibility to execution run planners in integrating runtime limits/considerations when formulating how to approach software testing operations. The result is more resilient and more flexible software testing approaches that in turn lead to better software testing, which eliminates/reduces the need for repeat software testing operations through reducing the number of erroneous software testing operations. In some embodiments, by reducing the number of erroneous testing operations by decoupling execution plan management from execution run management, various embodiments of the present invention improve the operational efficiency of test automation platforms by reducing the number of processing operations that need to be executed by the noted test automation platforms in order to enable software testing operations (e.g., automated software testing operations). By reducing the number of processing operations that need to be executed by the noted test automation platforms in order to execute software testing operations, various embodiments of the present invention make important technical contributions to the field of software application testing. Accordingly, by enhancing the accuracy and reliability of automated testing workflow data entities generated by software testing engineers, the user-friendly and intuitive automated testing workflow generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

FIG. 3 is a flowchart diagram of an example process 300 for performing a set of software testing operations. Via the various steps/operations of the process 300, the web server computing entity 104 can enable performing software testing operations based at least in part on either or both of: (i) execution run data entities that are generated based at least in part on execution plan data entities, and (ii) implicitly-generated for worksheet execution run data entities, where the worksheet execution run data entities are generated based at least in part on previously-documented execution run data entities.

The process 300 begins at step/operation 301 when the web server computing entity 104 generates an execution plan data entity. The execution plan data entity may describe a collection of test case data entities, a set of set of execution plan definition tags, and/or a set of test case data entity folders. For example, an execution plan data entity may describe a set of test case data entities that are generated based at least in part on a set of execution plan definition tags. In some embodiments, when an execution plan data entity is determined based at least in part on a set of test case data entities that are generated based at least in part on set of execution plan definition tags, the execution plan data entity may be referred to herein as a “dynamic execution plan data entity.” As another example, an execution plan data entity may describe a set of test case data entities that are explicitly selected by an end user of the web server computing entity 104. In some embodiments, when an execution plan data entity describes a set of test case data entities that are explicitly selected by an end user of the web server computing entity 104, the execution plan data entity may be referred to herein as a “static execution plan data entity.” Moreover, as described herein, the set of test case data entities described by an execution plan data entity may be referred to as the planned test case subset for the execution plan data entity. In some embodiments, execution plan data entities include worksheet execution run data entities that are generated based at least in part on previously-documented execution run data entities, as further described below.

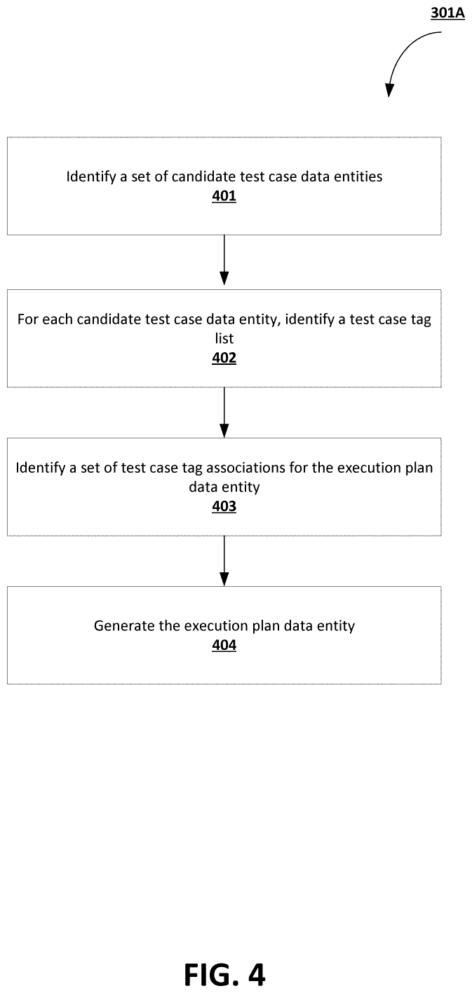

In some embodiments, step/operation 301 may be performed in accordance with the process 301A that is depicted in FIG. 4, which is an example process for dynamically generating an execution plan data entity based at least in part on a set of test case tags, such as a set of included test case tags and/or a set of excluded test case tags. The process 301A that is depicted in FIG. 4 begins at step/operation 401 when the web server computing entity 104 identifies a set of candidate test case data entities associated with the web server computing entity 104. The set of test case data entities may include all of the test case data entities associated with the web server computing entity 104 (e.g., the set of all of the test case data entities stored in a storage platform associated with the web server computing entity 104) that are deemed accessible to a target end user of the web server computing entity 104, in accordance with a set of user permissions associated with the web server computing entity 104. In some embodiments, the set of test case data entities include all of the test case data entities associated with the web server computing entity 104 (e.g., the set of all of the test case data entities stored in a storage platform associated with the web server computing entity 104).

In general, a test case data entity may describe data associated with a test case, where the test case may in turn describe a specification of the inputs, execution conditions, testing procedure, and expected results (e.g., including explicitly defined assertions as well as implicitly generated expected results such as the expected result that typing a value into a field causes the value to appear in the field) that define a test that is configured to be executed to achieve a particular software testing objective, such as to exercise a particular program path or to verify compliance with a specific operational requirement. In some embodiments, the test case data entity may be configured to describe test case data (e.g., webpage sequence data, user interaction sequence data, and/or the like) associated with a corresponding test case. In some embodiments, a test case data entity is configured to describe: (i) one or more test case page images associated with the test case, and (ii) for each test case page image of the one or more test case page images, a set of test case steps that relate to the test case page image.

A test case page image may be an image associated with a state of a webpage that is visited during a test. For example, in some embodiments, a test case page image may depict a webpage image that is determined based at least in part on a session data entity associated with the test case data entity (as further described below). As another example, in some embodiments, a test case page image may depict a user-uploaded and/or user-selected image that is configured to depict a state of a webpage associated with a corresponding test case data entity. In some embodiments, each visited webpage associated with a test case data entity may be associated with more than one test case page image, where each test case page image may depict a different state of the visited webpage. For example, consider a webpage that includes a dropdown menu interactive page element. In the noted example, some test case page images associated with the webpage may depict a visual state of the webpage in which the dropdown menu interactive page element is in a non-expanded state, while other test case page images associated with the webpage may depict a visual state of the webpage in which the dropdown menu interactive page element is in an expanded state. As another example, consider a webpage that is configured to generate a transitory notification (e.g., a transitory notification that is generated in response to a defined user action, such as in response to the user hovering over an interactive page element and/or in response to the user selecting an interactive button). In the noted example, some test case page images associated with the webpage may depict a visual state of the webpage in which the transitory notifications are displayed, while other test case page images associated with the webpage may depict a visual state of the webpage in which the transitory notifications are not displayed.

A test case step may describe a user action required by a test associated with a corresponding test case data entity, where the user action may be performed with respect to an interactive page element of a webpage associated with a test case page image of the corresponding test case data entity. In some embodiments, a test case step may be associated with test case data used to generate at least one of the following: (i) a visual element identifier overlaid on the test case page image in an overlay location associated with a region of the test case page image that corresponds to the interactive page element for the test case step (e.g., is defined in relation to the interactive page element, for example, is placed at the upper left of the interactive page element); and (ii) a test case step action feature that describes one or more action features of the user action associated with the test case step. For example, if a test case step corresponds to the user action of selecting a particular button on a particular webpage, the test case step may describe data corresponding to a visual element identifier overlaid on an image region of a test case page image for the particular webpage that corresponds to (e.g., is defined in relation to) a location of the particular button on the particular webpage. In the noted example, the test case step may describe data associated with action features of a user action that may be used to generate a test case step action feature. An action feature of a user action may describe any property of a user action that is configured to change a state and/or a value of an interactive page element within a webpage. Examples of action features for a user action include (i) a user action type of the user action that may describe a general input mode of user interaction with the interactive page element associated with the user action; (ii) a user input value of the user action that may describe a value provided by the user to an interactive page element; (iii) a user action sequence identifier of the user action that may describe a temporal order of the user action within a set of sequential user actions performed with respect to interactive page elements of a webpage associated with the user action; and (iv) a user action time of the user action that may describe a captured time of the corresponding user action, and/or the like.

At step/operation 402, the web server computing entity 104 identifies a test case tag list for each candidate test case data entity. A test case tag list for a test case data entity may describe a set of user-defined labels for the entirety of the test case data entity, such as a tag that is assigned to the test case data entity when an end user interacts with a test case visualization user interface associated with the test case data entity. In some embodiments, if a candidate test case data entity is not associated with any user-defined labels for the entirety of the test case data entity, then the test case tag list for the candidate test case data entity may be empty.

At step/operation 403, the web server computing entity 104 identifies a set of test case tag associations for the execution plan data entity. The set of test case tag associations may describe at least one of the following: (i) a set of included test case tags for a corresponding execution plan data entity, such that if a candidate test case data entity in a set of candidate test case data entities includes at least one of the set of included test case tags, then the candidate test case data entity should be added to a set of test case data entities described by the corresponding execution plan data entity; and (ii) a set of excluded test case tags for a corresponding execution plan data entity, such that if a candidate test case data entity in a set of candidate test case data entities includes any one or more of the set of excluded test case tags, then the candidate test case data entity should be excluded from a set of test case data entities described by the corresponding execution plan data entity even if the candidate test case data entity is associated with at least one of the included test case tags.

At step/operation 404, the web server computing entity 104 generates the execution plan data entity based at least in part on the set of test case tag associations. In some embodiments, in addition to describing the set of test case tag associations, the execution plan data entity is generated based at least in part on one or more user-specified features for the execution plan data entity, such as a short description for the execution plan data entity and a long description for the execution plan data entity. In some embodiments, in addition to describing the set of test case tag associations, such as a latest modification timestamp of a latest modification of the execution plan data entity, a latest modifier user profile for a latest modification of the execution plan data entity, an execution run history of the execution plan data entity, and a modification history profile for the execution plan data entity.

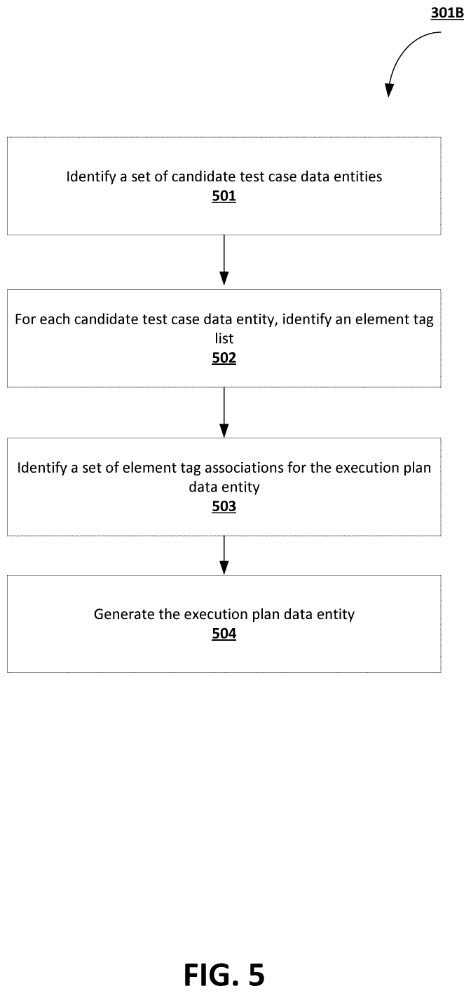

In some embodiments, step/operation 301 may be performed in accordance with the process 301B that is depicted in FIG. 5, which is an example process for dynamically generating an execution plan data entity based at least in part on a set of element tags, such as a set of included element tags and/or a set of excluded element tags. The process 301B that is depicted in FIG. 5 begins at step/operation 501 when the web server computing entity 104 identifies a set of candidate test case data entities associated with the web server computing entity 104. The set of test case data entities may include all of the test case data entities associated with the web server computing entity 104 (e.g., stored in a storage platform associated with the web server computing entity 104) that are deemed accessible to a target end user of the web server computing entity 104, in accordance with a set of user permissions associated with the web server computing entity 104. In some embodiments, the set of test case data entities include all of the test case data entities associated with the web server computing entity 104 (e.g., stored in a storage platform associated with the web server computing entity 104).

At step/operation 502, the web server computing entity 104 identifies an element tag list for each candidate test case data entity. An element tag list for a test case data entity may describe a set of user-defined labels for a set of interactive page elements that are associated with a set of test case steps of the test case data entity. As described above, a test case data entity may be associated with a set of test case steps, where each test case step may in turn be associated with an interactive page element of a webpage that is associated with a test case page image for the test case data entity. In some embodiments, the web server computing entity 104 may enable an end user to define labels for particular interactive page elements of particular test case steps of a test case data entity, and these defined labels may be aggregated to generate the element tag list for the test case data entity. For example, consider a test case step that is associated with two webpages W1 and W2, where the test case page image for W1 is in turn associated with a test case step S1 for an interactive page element E1 having a user-defined element label L1, and a test case step S2 for an interactive page element E2 that does not have a user-defined element label, while the test case page image for W2 is in turn associated with a test case step S3 for an interactive page element E3 having a user-defined element label L3, and a test case step S4 for an interactive page element E4 that does not have a user-defined element label. In the noted exemplary scenario, the element tag list for the exemplary test case data entity comprises L1 and L3. In some embodiments, if a candidate test case data entity is not associated with any user-defined element labels for any of its corresponding interactive page elements, then the element tag list for the candidate test case data entity may be empty.

At step/operation 503, the web server computing entity 104 identifies a set of element tag associations for the execution plan data entity. The set of element tag associations may describe at least one of the following: (i) a set of included element tags for a corresponding execution plan data entity, such that if the element tag list for a candidate test case data entity in a set of candidate test case data entities includes at least one of the set of included element tags, then the candidate test case data entity should be added to a set of test case data entities described by the corresponding execution plan data entity; and (ii) a set of excluded element tags for a corresponding execution plan data entity, such that if a candidate test case data entity in a set of candidate test case data entities includes any one or more of the set of excluded element tags, then the candidate test case data entity should be excluded from a set of test case data entities described by the corresponding execution plan data entity even if the candidate test case data entity is associated with at least one of the included element tags.

In some embodiments, to generate the planned test case subset for an execution plan data entity based at least in part on the set of element tag associations for the execution plan data entity, the web server computing entity 104 first generates a set of test case data entities whose element tag list comprises at least one of the included element tags defined by the element tag associations, and then excludes from the noted set of test case data entities any test case data entities whose element tag list comprises any of the excluded element tags defined by element tag associations.

At step/operation 504, the web server computing entity 104 generates the execution plan data entity based at least in part on the set of element tag associations. In some embodiments, in addition to describing the set of element tag associations, the execution plan data entity is generated based at least in part on one or more user-specified features for the execution plan data entity, such as a short description for the execution plan data entity and a long description for the execution plan data entity. In some embodiments, in addition to describing the set of element tag associations, the execution plan data entity is generated based at least in part on one or more inferred features for the execution plan data entity, such as a latest modification timestamp of a latest modification of the execution plan data entity, a latest modifier user profile for a latest modification of the execution plan data entity, an execution run history of the execution plan data entity, and a modification history profile for the execution plan data entity.

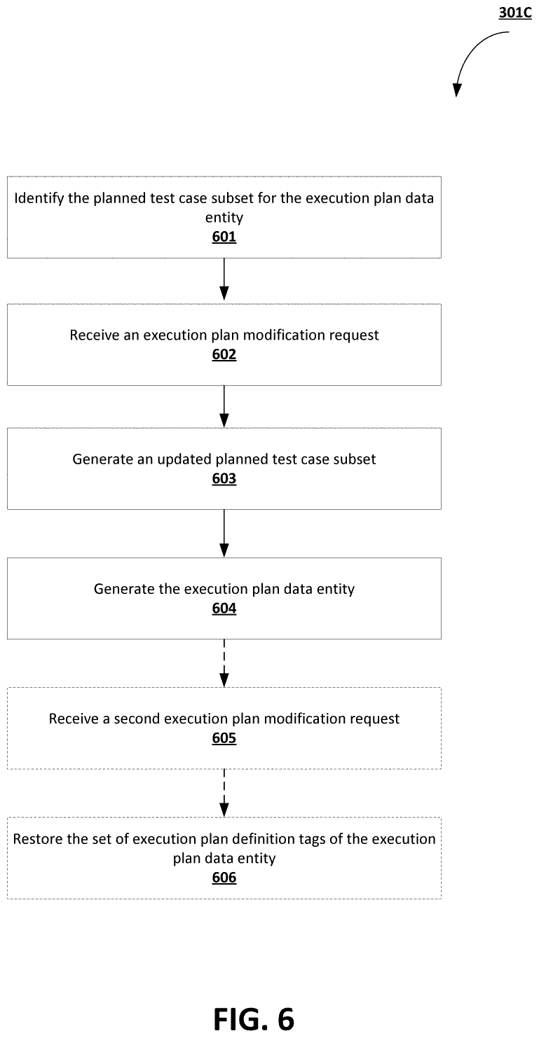

In some embodiments, step/operation 301 may be performed in accordance with the process 301C that is depicted in FIG. 6, which is an example process for generating an execution plan data entity by statically updating a dynamic execution plan data entity, such as a dynamic execution plan data entity that is generated using at least one of the process 301A of FIG. 5 or the process 301B of FIG. 6. The process 301C that is depicted in FIG. 6 begins at step/operation 601 when the web server computing entity 104 identifies the planned test case subset for the execution plan data entity which is a dynamic execution plan data entity. As described above, a planned test case subset may include each test case data entity in a set of candidate test case data entities that is described by a corresponding execution plan data entity.

Therefore, while for a static execution plan data entity the described set of test case data entities may include those test case data entities explicitly defined by a target end user, for a dynamic execution plan data entity the described set of test case data entities may include those test case data entities that correspond to dynamic selection criteria defined by a set of execution plan definition tags for the dynamic execution plan data entity, such as at least one of one or more included test case tags for the dynamic execution plan data entity, one or more excluded test case tags for the dynamic execution plan data entity, one or more included element tags for the dynamic execution plan data entity, and one or more excluded elements tags for the dynamic execution plan data entity.

As described above, the dynamic execution plan may be determined based at least in part on a set of execution plan definition tags, where an execution plan definition tag may be a tag that may be associated with at least a part of a test case data entity, where such an association may be deemed to render the test case data entity eligible or ineligible for inclusion as part of the planned test case data entities described by an execution plan data entity that is associated with the set of execution plan definition tags. Examples of execution plan definition tags included test case tags, excluded test case tags, included test case image tags, excluded test case image tags, included element tags, excluded element tags, included test case step action feature tags, excluded test case step action feature tags, and/or the like.

At step/operation 602, the web server computing entity 104 receives an execution plan modification request to change an execution plan definition type of the execution plan data entity to a static execution plan definition type (e.g., from a dynamic execution plan definition type). An execution plan definition type may describe whether a corresponding execution plan data entity is a dynamic execution plan or a static execution plan. As described above, when an execution plan data entity is determined based at least in part on a set of test case data entities that are generated based at least in part on set of execution plan definition tags, the execution plan data entity may be referred to herein as a “dynamic execution plan data entity,” while when an execution plan data entity describes a set of test case data entities that are explicitly selected by an end user of the web server computing entity 104, the execution plan data entity may be referred to herein as a “static execution plan data entity.” In some embodiments, a dynamic execution plan data entity has a dynamic execution plan definition type and a static execution plan data entity has a static execution plan definition type. In some embodiments, the existing execution plan data entity of an execution plan data entity may be modified using an execution plan modification request, such as an execution plan modification request to change the execution plan definition type of an execution plan data entity from a dynamic execution plan definition type to a static execution plan definition type, or an execution plan modification request to change the execution plan definition type of an execution plan data entity from a static execution plan definition type to a dynamic execution plan definition type.

At step/operation 603, in response to receiving the execution plan modification request at step/operation 602, the web server computing entity 104 enables an end user of the web server computing entity 104 to generate an updated planned test case subset by modifying the planned test case subset, e.g., by adding new candidate test case data entities that are not in the planned test case subset to the planned test case subset and/or by skipping existing candidate test case data entities that are in the planned test case subset from the planned test case subset. In some embodiments, as part of step/operation 603, the web server computing entity 104 modifies the execution plan definition type of the execution plan data entity from a dynamic execution plan definition type to a static execution plan definition type.

At step/operation 604, the web server computing entity 104 generates the execution plan data entity based at least in part on the updated planned test case subset. In some embodiments, in addition to describing each test case data entity in the updated planned test case subset, the execution plan data entity is generated based at least in part on one or more user-specified features for the execution plan data entity, such as a short description for the execution plan data entity and a long description for the execution plan data entity. In some embodiments, in addition to describing each test case data entity in the updated planned test case subset, the execution plan data entity is generated based at least in part on one or more inferred features for the execution plan data entity, such as a latest modification timestamp of a latest modification of the execution plan data entity, a latest modifier user profile for a latest modification of the execution plan data entity, an execution run history of the execution plan data entity, and a modification history profile for the execution plan data entity.

At step/operation 605, the web server computing entity 104 optionally receives a second execution plan modification request to change an execution plan definition type of the execution plan data entity to a dynamic execution plan definition type (e.g., from a static execution plan definition type). As described above, in some embodiments, the existing execution plan data entity of an execution plan data entity may be modified using an execution plan modification request, such as an execution plan modification request to change the execution plan definition type of an execution plan data entity from a dynamic execution plan definition type to a static execution plan definition type, or an execution plan modification request to change the execution plan definition type of an execution plan data entity from a static execution plan definition type to a dynamic execution plan definition type.

At step/operation 606, in response to receiving the second execution plan modification request, the web server computing entity 104 optionally restores the set of execution plan definition tags of the execution plan data entity as default (e.g., preset, recommended, prefilled, and/or the like) execution plan definition tags for the execution plan data entity. In some embodiments, after indicating a desire to modify the execution plan definition type of the execution plan data entity to a dynamic execution plan definition type, the web server computing entity 104 generates a set of execution plan definition tags for the newly-generated dynamic execution plan data entity that are determined based at least in part on the set of execution plan definition tags for the pre-existing dynamic execution plan data entity. In some embodiments, as part of step/operation 606, the web server computing entity 104 modifies the execution plan definition type of the execution plan data entity from a static execution plan definition type to a dynamic execution plan definition type.

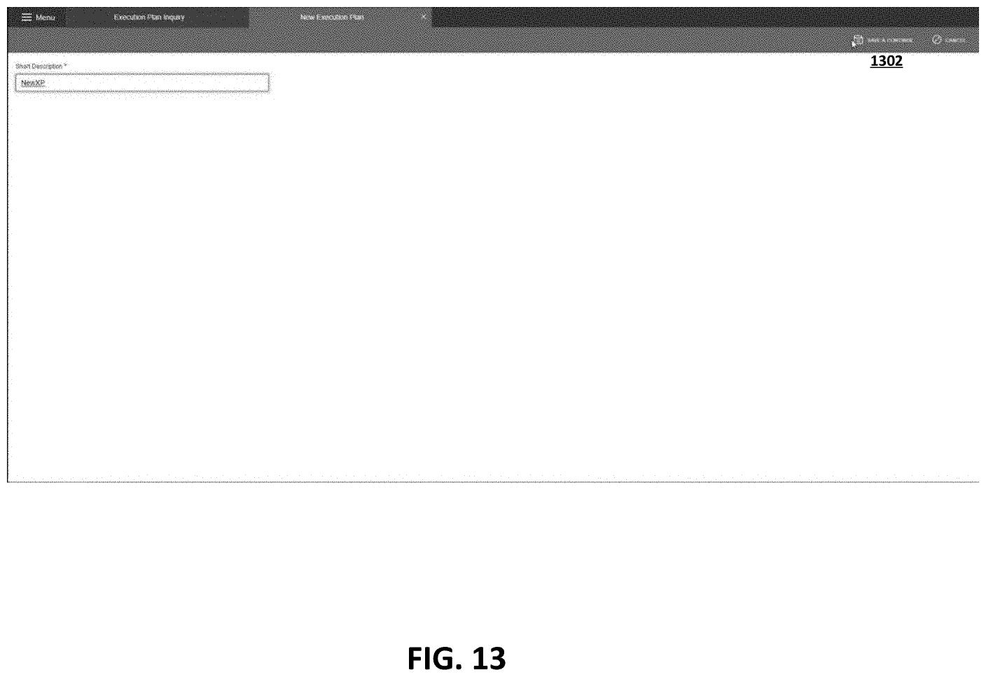

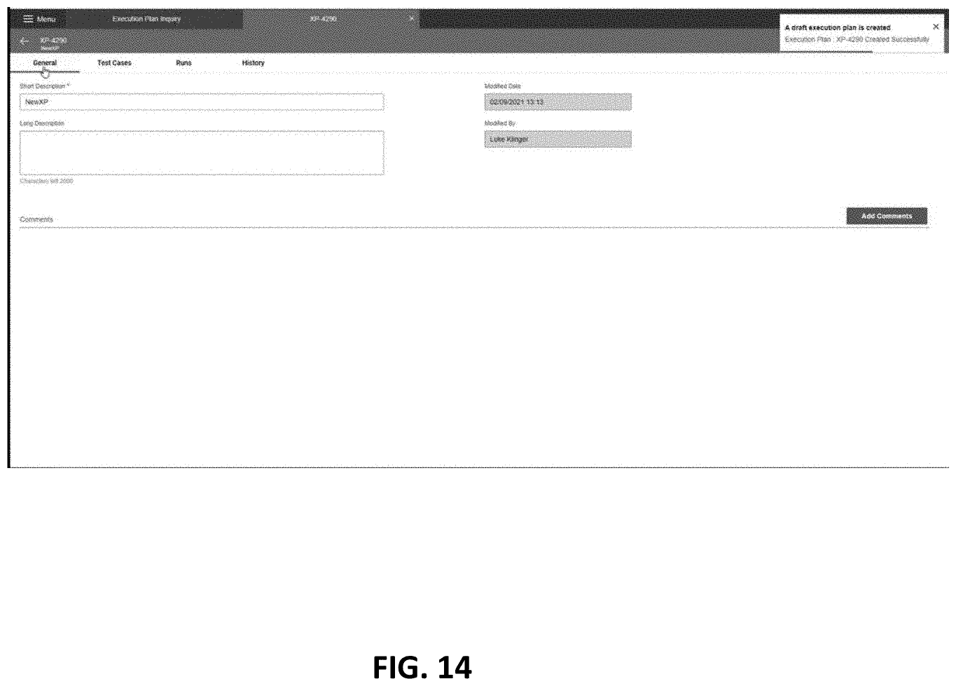

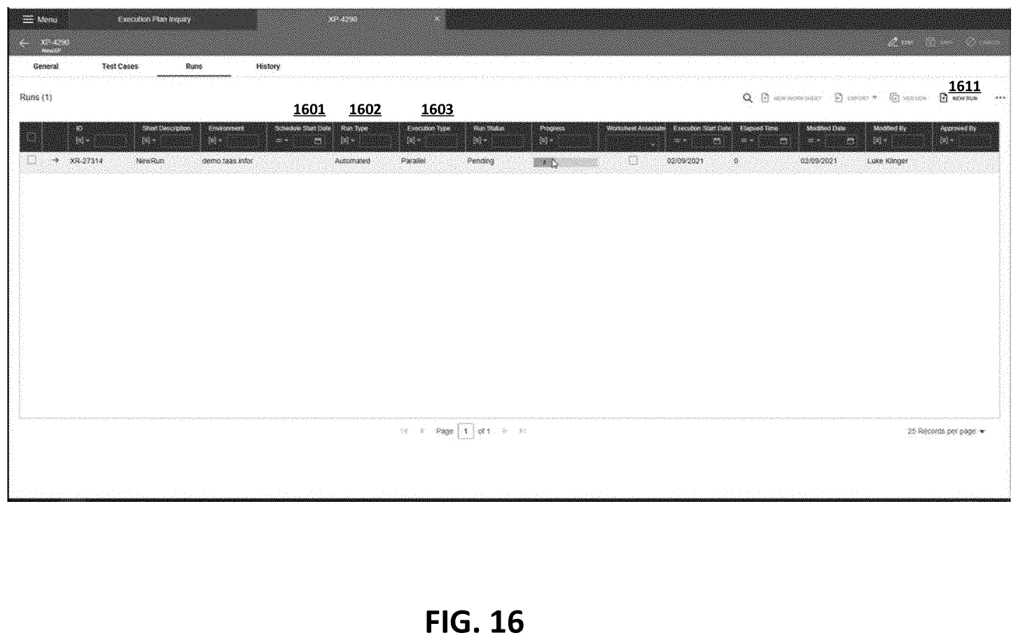

An operational example of generating an execution plan data entity is depicted in FIG. 16A. The webpage depicted in FIG. 16A is presented after the user provides a short description for a new execution plan data entity and selects the button 1302 in the webpage of FIG. 13. Selection of the button 1302 leads to generating the webpage platform associated with the webpages depicted in FIGS. 14-17. In particular, the webpage depicted in FIG. 14 enables modifying the short description and the long description of the execution plan data entity, viewing the latest modification date and the latest modifier user profile of the execution plan data entity, viewing any comments associated with the execution plan data entity, and adding new comments for the execution plan data entity.

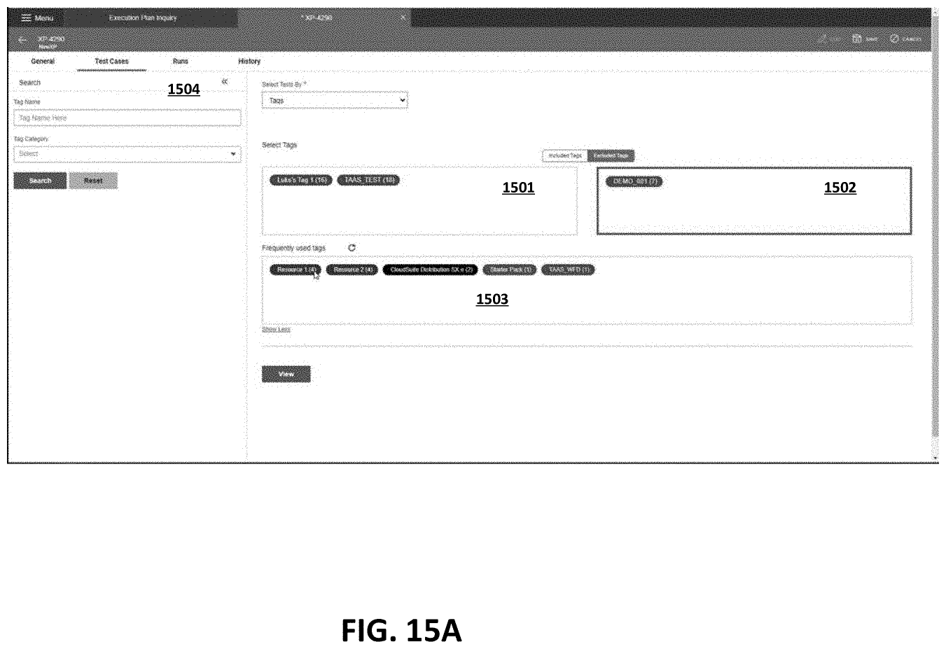

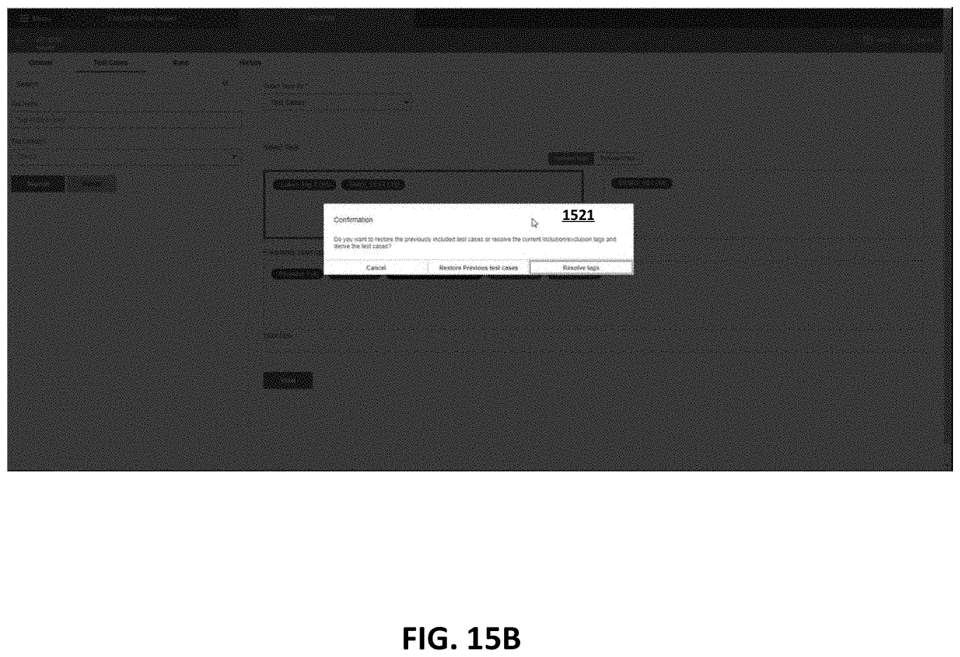

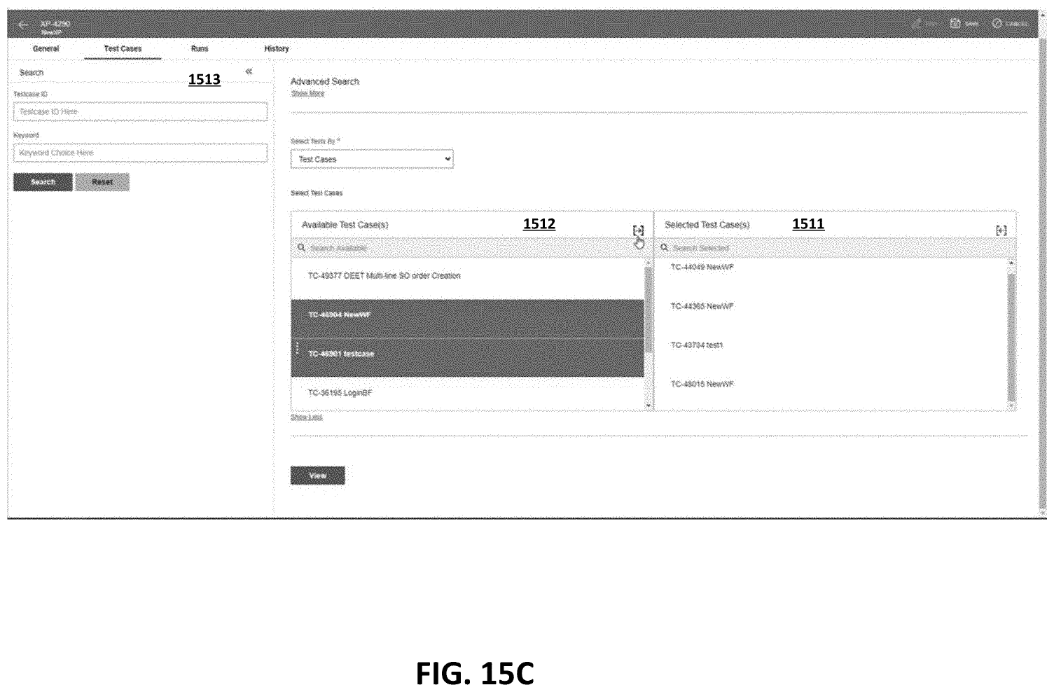

In addition, the webpage depicted in FIGS. 15A-15C enables modifying the planned test case subset for the execution plan data entity. In particular, while in the “Tags” mode (as depicted in FIG. 15A), the webpage enables generating a dynamic execution plan data entity based at least in part on the set of included tags 1501 and the set of excluded tags 1502, where tags may be selected using the tag selection panel 1503. When the user has not specified any search parameters using the search panel 1504, the tag selection panel 1503 depicts the most frequently used tags. When the user has specified search parameters using the search panel 1504, the tag selection panel 1503 depicts the search results. Moreover, while in the “Test Cases” mode (as depicted in FIG. 15C), the webpage enables generating static execution plan data entities using the manually-selected planned test case subset 1511 that includes test case data entities selected from the test case selection panel 1512, where the candidate test case data entities depicted using the test case selection panel 1512 may be returned by a test case search performed in accordance with search parameters defined using the test case search panel 1513. In some embodiments, the user can generate an execution plan modification request by changing from the “Tags” mode to the “Test Cases” mode and vice versa, where such a requested change may trigger a confirmatory notification by the webpage, such as the confirmatory notification 1521 of FIG. 15B.

Furthermore, the webpage depicted in FIG. 16 enables viewing features of existing execution run data entities associated with the execution plan data entities, including execution run identifiers of the existing execution run data entities, short descriptions of the existing execution run data entities, execution run web environment parameters 1601 of the existing execution run data entities, execution run scheduling parameters 1602 of the existing execution run data entities, execution run automation parameters 1603 of the existing execution run data entities, execution run parallelization parameters of the existing execution run data entities, run statuses of the existing execution run data entities, progress ratios of the existing execution run data entities, worksheet association indicators of the existing execution run data entities, temporal features associated with execution times of the existing execution run data entities, and/or the like. The webpage depicted in FIG. 16 further enables generating a new execution data run data entity for the execution plan data entity using the button 1611.

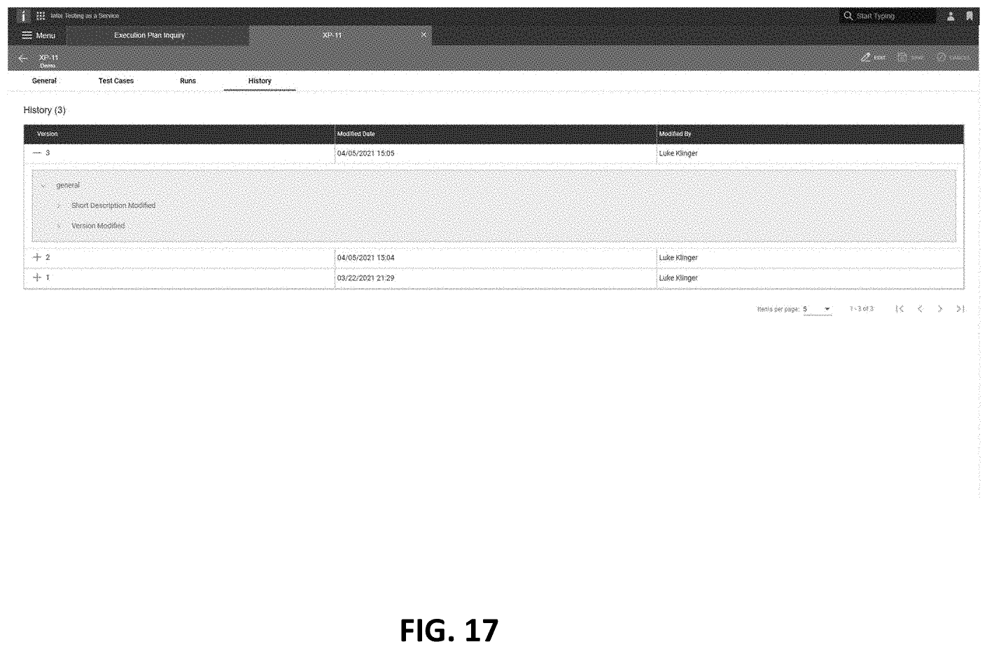

Moreover, the webpage depicted in FIG. 17 depicts a revision history of all modifications to the execution plan data entity. For each recorded modification, the webpage depicts a modifier user profile, a modification time, and a description of all changes made as a result of the noted recorded modification.

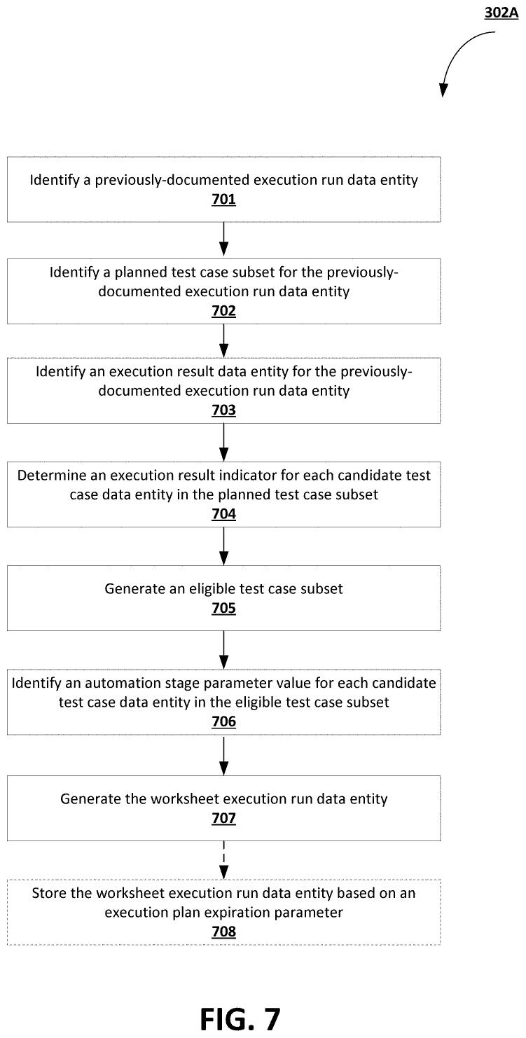

In some embodiments, step/operation 302 may be performed in accordance with the process 302A that is depicted in FIG. 7, which is an example process for generating a worksheet execution run data entity based at least in part on a previously-documented execution run data entity. A worksheet execution run data entity may be an execution run data entity that is generated based at least in part on filtering a planned test case subset for a previously-documented execution run data entity in accordance with an execution result data entity for the previously-documented execution run data entity and an execution result indicator for each candidate test case data entity in the planned test case subset. For example, in some embodiments, a worksheet execution run data entity may be generated by performing the following operations: (i) generating an eligible test case subset for the worksheet execution run data entity based at least in part on filtering the planned test case subset for the previously-documented execution run data entity, wherein filtering the planned test case subset is performed based at least in part on whether each execution result indicator for a candidate test case data entity in the planned test case subset is described by an execution result parameter for the previously-documented execution run data entity; and (ii) generating the worksheet execution run data entity based at least in part on an automation stage parameter value for each candidate test case data entity in the eligible test case subset. In some embodiments, a worksheet execution run data entity is stored by the web server computing entity 104 in a storage platform associated with the web server computing entity 104 only for a time period defined by an execution plan expiration parameter for the worksheet execution run data entity. In some embodiments, each previously-documented execution run data entity is associated with a single worksheet execution run data entity.

In some embodiments, if a user is viewing a worksheet execution run data entity at the time that the worksheet execution run data entity is replaced, the user is prompted that the worksheet execution run data entity has been updated and given access to the updated worksheet execution run data entity. In some embodiment, when a user is creating a new worksheet execution run data entity from an execution run data entity and the execution run data entity already has an existing worksheet execution run data entity associated with it, the user is prompted to replace the existing worksheet execution run data entity or open the existing worksheet execution run data entity. In some embodiments, when during the process of working on a worksheet execution run data entity another user selects to create a new version of the worksheet execution run data entity, the proposed system forces a new execution run of the worksheet execution run data entity and updates the worksheet execution run data entity based on the results of the new execution run of the worksheet execution run data entity.

The process 302A that is depicted in FIG. 7 begins at step/operation 701 when the web server computing entity 104 identifies a previously-documented execution run data entity. A previously-documented execution run data entity may be an execution run data entity that has been executed at least once before, such that each candidate test case data entity in a planned test case subset for the previously-documented execution run data entity is associated with an execution result indicator as described by an execution result data entity for the previously-documented run data entity. For example, the execution result data entity for a previously-documented execution run data entity may describe whether, for each candidate test case data entity in the planned test case subset for the previously-documented execution run data entity, the candidate test case data entity is associated with one or more of the following: (i) a negative test case result indicator describing failure of the candidate test case data entity in a latest execution of previously-documented execution run data entity; (ii) a positive skipping indicator describing that the candidate test case data entity has been skipped by skipping the candidate test case data entity in a latest execution of previously-documented execution run data entity; (iii) an automation stage parameter value describing that the candidate test case data entity is not associated with an execution readiness value (i.e., is not ready for execution); (iv) a negative precondition passage indicator describing that the candidate test case data entity has failed or skipped its defined preconditions in a latest execution of previously-documented execution run data entity; (v) an affirmative auto-skipping indicator describing that the candidate test case data entity has been auto-skipped in a latest execution of previously-documented execution run data entity, (vii) an affirmative execution skipping indicator describing that the candidate test case data entity has been skipped in a latest execution of previously-documented execution run data entity, and (viii) a failure or skipping indicator describing that the candidate test case data entity has had either a negative test case result indicator or a positive skipping indicator in a latest execution of previously-documented execution run data entity.

At step/operation 702, the web server computing entity 104 identifies a planned test case subset of a set of candidate test case data entities for the previously-documented execution run data entity. In some embodiments, the planned test case subset is the planned test case subset for an execution plan data entity that has been used to generate the previously-documented execution run data entity. As described above, a planned test case subset may include each test case data entity in a set of candidate test case data entities that is described by a corresponding execution plan data entity.

At step/operation 703, the web server computing entity 104 identifies an execution result data entity for the previously-documented execution run data entity. The execution result data entity may describe an execution result indicator for each candidate test case data entity in the planned test case subset for a corresponding previously-documented execution run data entity. For example, the execution result data entity for a previously-documented execution run data entity may describe whether, for each candidate test case data entity in the planned test case subset for the previously-documented execution run data entity, the candidate test case data entity is associated with one or more of the following: (i) a negative test case result indicator describing failure of the candidate test case data entity in a latest execution of previously-documented execution run data entity (e.g., enabling a user to generate a worksheet execution run data entities based only on test case data entities that have not previously “passed”); (ii) a positive skipping indicator describing that the candidate test case data entity has been skipped by removing the candidate test case data entity in a latest execution of previously-documented execution run data entity; (iii) an automation stage parameter value describing that the candidate test case data entity is not associated with an execution readiness value (i.e., is not ready for execution); (iv) a negative precondition passage indicator describing that the candidate test case data entity has failed or skipped its defined preconditions in a latest execution of previously-documented execution run data entity; (v) an affirmative auto-skipping indicator describing that the candidate test case data entity has been auto-skipped in a latest execution of previously-documented execution run data entity; (vii) an affirmative execution skipping indicator describing that the candidate test case data entity has been skipped in a latest execution of previously-documented execution run data entity; and (viii) a failure or skipping indicator describing that the candidate test case data entity has had either a negative test case result indicator or a positive skipping indicator in a latest execution of previously-documented execution run data entity.

At step/operation 704, the web server computing entity 104 determines an execution result indicator for each candidate test case data entity in the planned test case subset for the previously-documented execution run data entity based at least in part on the execution result data entity for the previously-documented execution run data entity. The execution result indicator for a candidate test case data entity may describe at least one of an execution readiness of the candidate test case data entity and the outcome of a previous set of one or more executions of the candidate test case data entities. As described above, an execution result data entity for a previously-documented (e.g., a previously-executed) execution run data entity may describe an execution result indicator for each candidate test case data entity in the planned test case subset for the corresponding previously-documented execution run data entity. For example, the execution result indicator for a candidate test case data entity that is in the planned test case subset for a previously-documented execution run data entity may describe whether the candidate test case data entity is associated with one or more of the following: (i) a negative test case result indicator describing failure of the candidate test case data entity in a latest execution of previously-documented execution run data entity; (ii) a positive skipping indicator describing that the candidate test case data entity has been skipped by removing the candidate test case data entity in a latest execution of previously-documented execution run data entity; (iii) an automation stage parameter value describing that the candidate test case data entity is not associated with an execution readiness value (i.e., is not ready for execution); (iv) a negative precondition passage indicator describing that the candidate test case data entity has failed or skipped its defined preconditions in a latest execution of previously-documented execution run data entity; (v) an affirmative auto-skipping indicator describing that the candidate test case data entity has been auto-skipped in a latest execution of previously-documented execution run data entity; (vii) an affirmative execution skipping indicator describing that the candidate test case data entity has been skipped in a latest execution of previously-documented execution run data entity; and (viii) a failure or skipping indicator describing that the candidate test case data entity has had either a negative test case result indicator or a positive skipping indicator in a latest execution of previously-documented execution run data entity.

At step/operation 705, the web server computing entity 104 generates an eligible test case subset for the worksheet execution run data entity. In some embodiments, step/operation 805 is performed by filtering the planned test case subset for the previously-documented execution run data entity, wherein filtering the planned test case subset may be performed based at least in part on whether each execution result indicator for a candidate test case data entity in the planned test case subset is described by an execution result parameter for the previously-documented execution run data entity. In some embodiments, the execution result parameter is selected by an end user using a selection panel that enables selecting one or more execution result states. In some embodiments, the noted selection panel describes, for each execution result state, a count of test case data entities among the test case set for the previously-documented execution run data entity that correspond to the execution result state.

An eligible test case subset for a worksheet execution run data entity may describe each candidate test case data entity in a planned test case subset for a previously-documented execution run data entity associated with the worksheet execution run data entity that is also associated with an execution result indicator described by the execution result parameter for the worksheet execution run data entity. In some embodiments, if the execution result indicator for a candidate test case data entity in the planned test case subset for a previously-documented execution run data entity describes that the execution result indicator corresponds to an execution result parameter for a worksheet execution run data entity, then the candidate test case data entity is included among the eligible test case subset for the worksheet execution run data entity. For example, if the execution result parameter for a worksheet execution run data entity describes requiring either of execution result states that are associated with a negative test case result indicator and a positive skipping indicator, then a candidate test case data entity is included in the eligible test case subset for the worksheet execution run data entity if the execution result indicator for the candidate test case data entity describes at least one of an execution result state that is associated with a negative test case result indicator and an execution result state that is associated with a positive skipping indicator.

Accordingly, the execution result parameter for a worksheet execution run data entity may describe desired/selected execution result states for execution result indicators of candidate test case data entities that are included in the eligible test case subset for the worksheet execution run data entity. For example, the execution result parameter for a worksheet execution run data entity may describe requiring either of execution result states that are associated with a negative test case result indicator and a positive skipping indicator to be included in the eligible test case subset for the worksheet execution run data entity. As another example, the execution result parameter for a worksheet execution run data entity may describe requiring both of execution result states that are associated with a negative test case result indicator and a positive skipping indicator to be included in the eligible test case subset for the worksheet execution run data entity.

Moreover, the execution result indicator for a candidate test case data entity may describe which execution result states are associated with the candidate test case data entity. For example, the execution result indicator for a candidate test case data entity that is in the planned test case subset for a previously-documented execution run data entity may describe whether the candidate test case data entity is associated with one or more of the following: (i) a negative test case result indicator describing failure of the candidate test case data entity in a latest execution of previously-documented execution run data entity; (ii) a positive skipping indicator describing that the candidate test case data entity has been skipped by removing the candidate test case data entity in a latest execution of previously-documented execution run data entity; (iii) an automation stage parameter value describing that the candidate test case data entity is not associated with an execution readiness value (i.e., is not ready for execution); (iv) a negative precondition passage indicator describing that the candidate test case data entity has failed or skipped its defined preconditions in a latest execution of previously-documented execution run data entity; (v) an affirmative auto-skipping indicator describing that the candidate test case data entity has been auto-skipped in a latest execution of previously-documented execution run data entity; (vii) an affirmative execution skipping indicator describing that the candidate test case data entity has been skipped in a latest execution of previously-documented execution run data entity; and (viii) a failure or skipping indicator describing that the candidate test case data entity has had either a negative test case result indicator or a positive skipping indicator in a latest execution of previously-documented execution run data entity. In this example, (i)-(viii) are examples of execution result states, one or more of which may be specified by the execution result indicator for a particular candidate test case data entity.

At step/operation 706, the web server computing entity 104 identifies an automation stage parameter value for each candidate test case data entity that is in the eligible test case subset for the worksheet execution run data entity. An automation stage parameter value may describe a defined/assigned state of test automation for a corresponding test case data entity. For example, the automation stage parameter value for a test case data entity may have an automation readiness value describing that the test case data entity is ready for automation by a test automation engineer. As another example, the automation stage parameter value for a test case data entity may have neither the automation readiness value nor the execution readiness value, describing that the test case data entity is not ready for automation by a test automation engineer, and that the test case data entity is not ready for manual execution and/or automated execution. In some embodiments, the automation stage parameter for a candidate test case data entity may be set to “not ready for automation” by an execution planner to prevent the candidate test case data entity from being included in the test case set for worksheet execution run data entities. In some embodiments, the automation stage parameter for a candidate test case data entity may be set to “not ready for automation” by an automation engineer to prevent the candidate test case data entity from being included in the test case set for worksheet execution run data entities.

At step/operation 707, the web server computing entity 104 generates the worksheet execution run data entity based at least in part on each automation stage parameter value for each candidate test case data entity in the eligible test case subset for the worksheet execution run data entity. In some embodiments, the worksheet execution run data entity is associated with each candidate test case data entity in the eligible test case subset for the worksheet execution run data entity whose automation stage parameter value has a value that is defined based at least in part on a selected se of acceptable automation stage parameter values. For example, in some embodiments, the worksheet execution run data entity is associated with each candidate test case data entity in the eligible test case subset for the worksheet execution run data entity whose automation stage parameter value has an execution readiness value.

At step/operation 708, the web server computing entity 104 optionally stores the worksheet execution run data entity for a time period defined by an execution plan expiration parameter for the worksheet execution run data entity. The execution plan expiration parameter may define a period of time during which a worksheet execution run data entity is maintained for access by end users of the web server computing entity 104. For example, the execution plan expiration parameter for a worksheet execution run data entity may describe that the worksheet execution run data entity should be maintained for a week only. In some embodiments, storing worksheet execution run data entities enables maintaining worksheet execution run data entities as temporarily-maintained worksheet execution run data entities, as opposed to permanently-maintained worksheet execution run data entities such as static worksheet execution run data entities and/or dynamic worksheet execution run data entities.

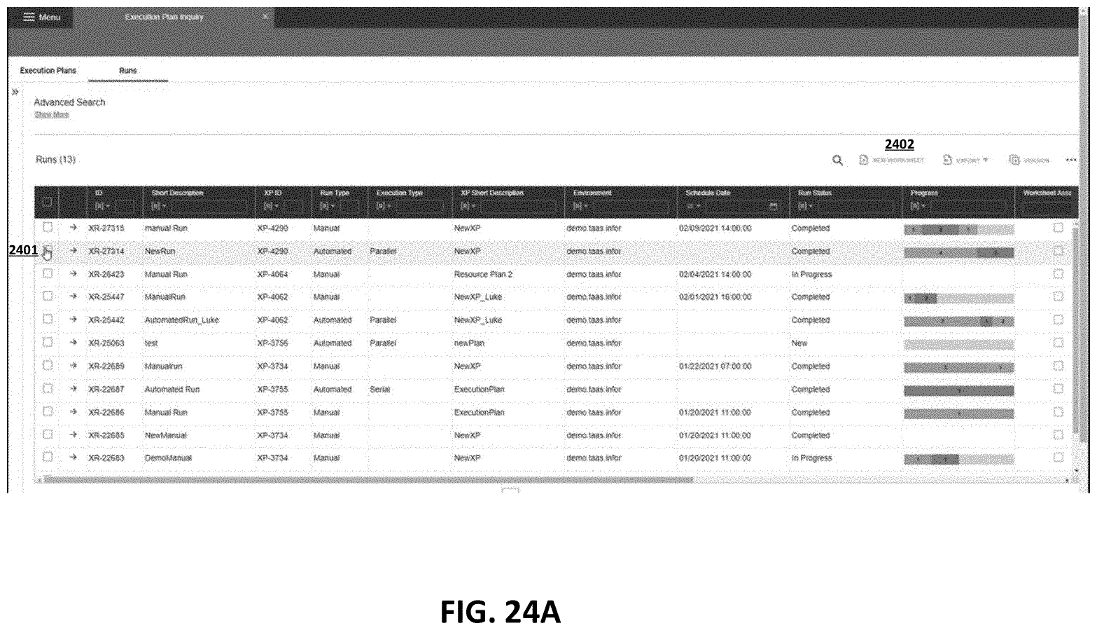

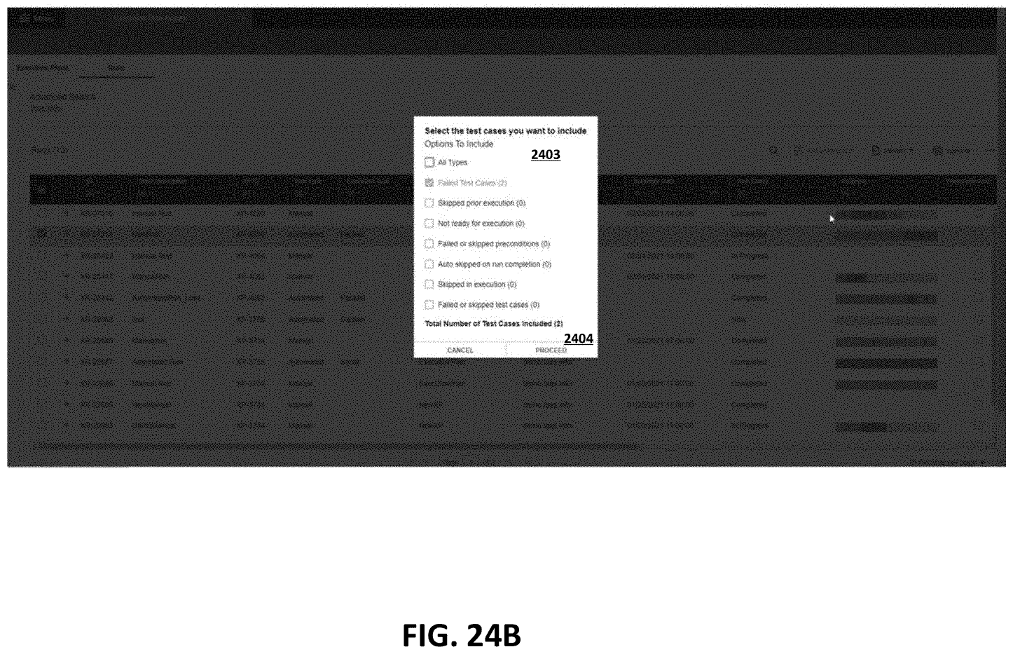

An operational example of generating a worksheet execution run data entity is depicted in FIGS. 24-27. As depicted in the webpage of FIG. 24A, a user first selects the previously-documented execution run data entity 2401 and selects the button 2402, which leads to the display of the selection box set 2403 as depicted in FIG. 24B. The selection box set 2403 enables selecting the execution result states corresponding to the execution result parameter for the worksheet execution run data entity. In particular the selection box set 2403 enables characterizing the execution result parameter for the worksheet execution run data entity with one or more of the following execution result states: (i) an execution result state defined by a negative test case result indicator describing failure of the candidate test case data entity in a latest execution of previously-documented execution run data entity; (ii) an execution result state defined by a positive skipping indicator describing that the candidate test case data entity has been skipped by removing the candidate test case data entity in a latest execution of previously-documented execution run data entity; (iii) an execution result state defined by an automation stage parameter value describing that the candidate test case data entity is not associated with an execution readiness value (i.e., is not ready for execution); (iv) an execution result state defined by a negative precondition passage indicator describing that the candidate test case data entity has failed or skipped its defined preconditions in a latest execution of previously-documented execution run data entity; (v) an execution result state defined by an affirmative auto-skipping indicator describing that the candidate test case data entity has been auto-skipped in a latest execution of previously-documented execution run data entity; (vii) an execution result state defined by an affirmative execution skipping indicator describing that the candidate test case data entity has been skipped in a latest execution of previously-documented execution run data entity; and (viii) an execution result state defined by a failure or skipping indicator describing that the candidate test case data entity has had either a negative test case result indicator or a positive skipping indicator in a latest execution of previously-documented execution run data entity.

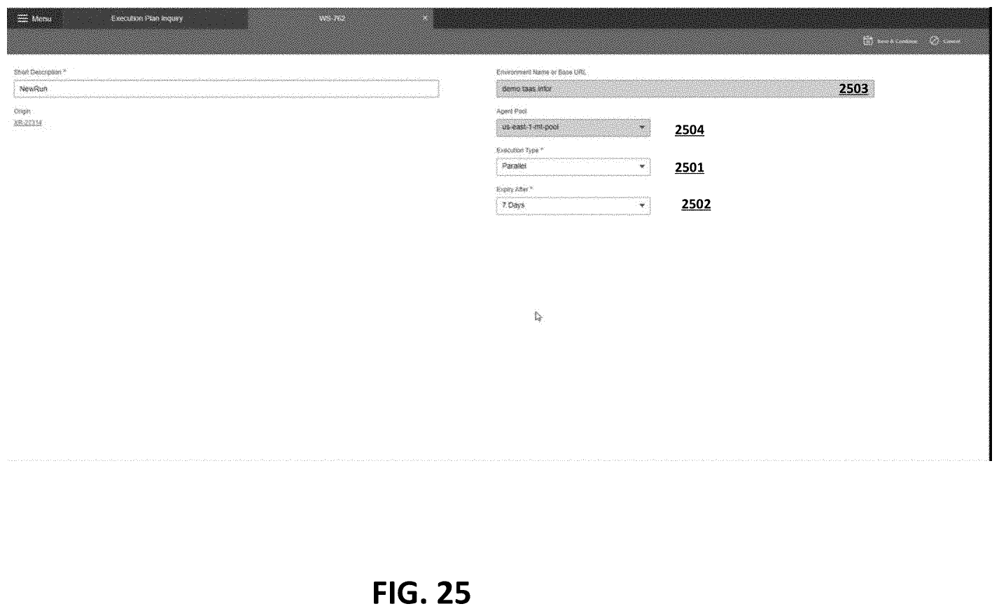

After the user selects the execution result parameter using the selection box set 2403 and selects the button 2404 as depicted in FIG. 24B, the webpage depicted in FIG. 25 is displayed. The webpage depicted in FIG. 25 enables defining a short description for the worksheet execution run data entity, an execution plan parallelization parameter 2501 for the worksheet execution run data entity, and an execution plan expiration parameter 2502 for the worksheet execution run data entity. The webpage depicted in FIG. 25 further enables viewing an execution plan web environment parameter 2503 for the worksheet execution run data entity and an execution plan agent pool 2504 for the worksheet execution run data entity.

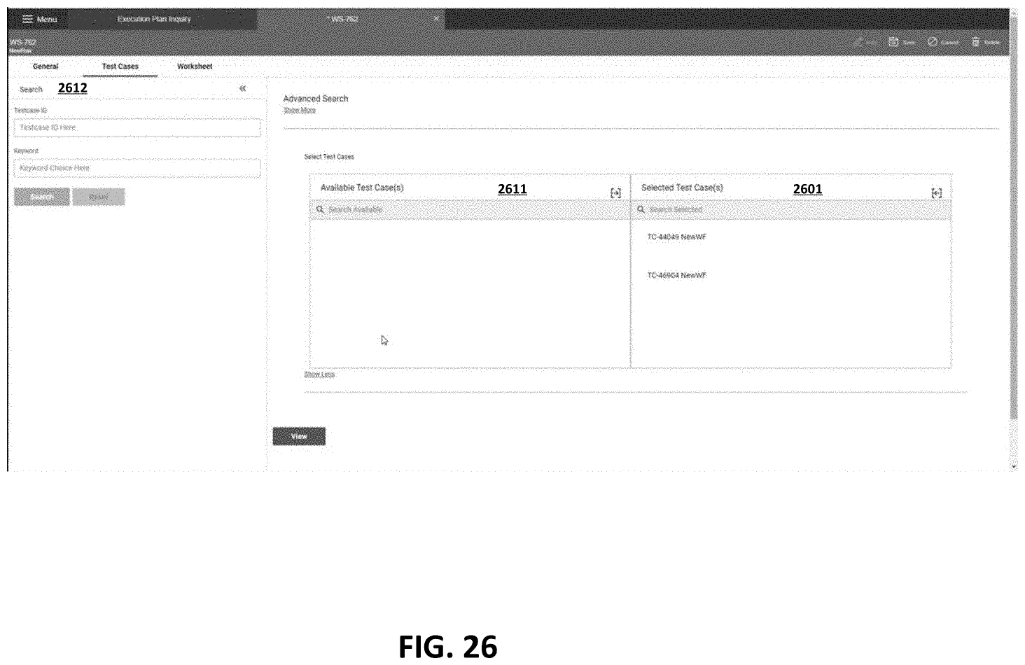

Furthermore, the webpage depicted in FIG. 26 enables modifying the eligible test case subset 2601 for the worksheet execution run data entity by adding new test case data entities to the eligible test case subset 2601 via selection of the new test case data entities from the test case selection panel 2611 and skipping of existing test case data entities from the eligible test case subset 2601 via selection of the existing test case data entities in the eligible test case subset 2601, which may in turn lead to addition of the skipped test case data entities to the test case selection panel 2611. In some embodiments, the candidate test case data entities that are depicted using the test case selection panel 2611 may be returned by a test case search performed in accordance with test case search parameters defined using the test case search panel 2612.

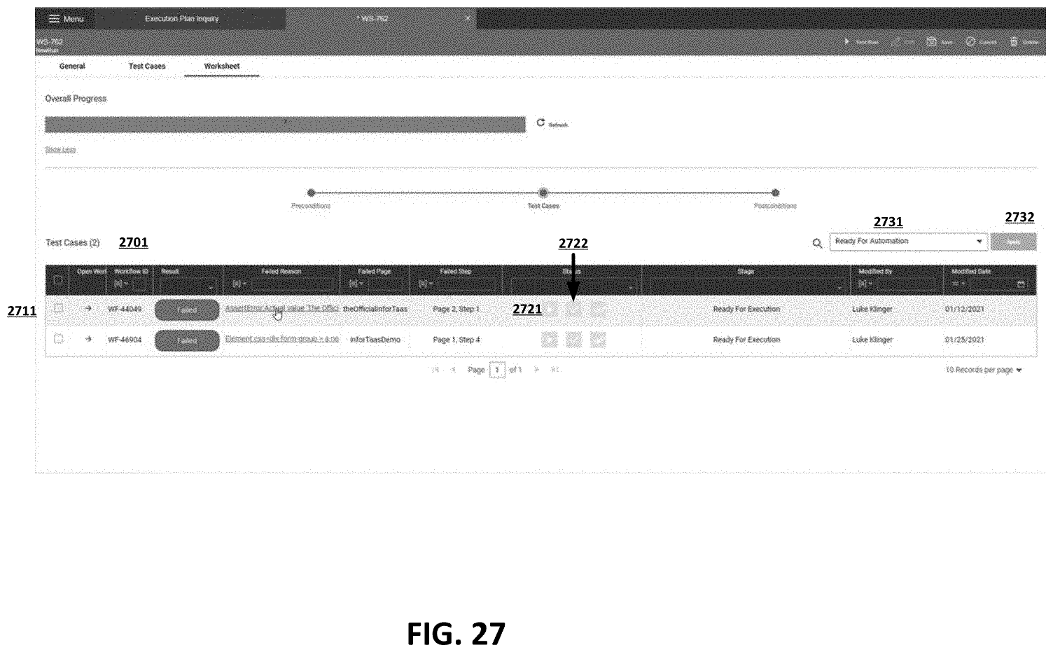

Moreover, the webpage depicted in FIG. 27 enables viewing the eligible test case subset 2701, skipping test case data entities from the eligible test case subset 2701 by marking them as skipped, and marking test case data entities in the eligible test case subset as being ready for execution. For example, for the test case data entity 2711, the test case data entity 2711 can be skipped from eligible test case subset 2701 using the button 2721 and can be marked as ready for execution using the button 2722. Moreover, the webpage depicted in FIG. 27 enables updating the automation stage parameter value for all depicted candidate test case data entities to describe an automation readiness value by setting the value of the dropdown menu 2731 to “Ready for Automation” and selecting the button 2732. In some embodiments, once generated, a worksheet execution run data entity enables tracking progress of generating automated testing workflow data entities for test case data entities; for example, an automation engineer may mark a test case data entity as “ready for execution” when an automated testing workflow data entity is generated for the noted test case data entity.

In some embodiments, the webpage depicted in FIG. 27 enables sorting test case data entities by “Failed Reason,” which enables grouping test case data entities that have failed with the same failure message. In some embodiments, this feature enables the automation engineer to fix the same issue across many test case data entities and re-run tests on those test case data entities to see if the noted issue has been fixed across all the affected test case data entities.

Returning to FIG. 3, at step/operation 302, the web server computing entity 104 generates an execution run data entity based at least in part on the execution plan data entity generated at step/operation 301. The execution run data entity may describe a defined execution of an execution plan data entity, such as a defined automated execution of an execution plan data entity or a defined manual execution of an execution plan data entity. In some embodiments, when an execution run data entity describes an automated execution of an execution plan data entity, the execution run data entity is referred to herein as an “automated execution run data entity.” In some embodiments, when an execution run data entity describes a manual execution of an execution plan data entity, the execution run data entity is referred to herein as a “manual execution run data entity.” In some embodiments, an execution run data entity is determined based at least in part on a set of execution run definition parameters for the execution run data entity, such as an execution run automation parameter for the execution run data entity that describes whether the execution run data entity is an automated execution run data entity or a manual execution run data entity; an execution run scheduling parameter for the execution run data entity that describes whether the execution run data entity should be executed once, periodically (e.g., in accordance with a defined periodicity), or in an on-demand manner as demanded by end users; an execution run parallelization parameter for the execution run data entity that describes whether the execution run data entity should be performed sequentially or in parallel; and an execution run web environment parameter for the execution run data entity that describes the Uniform Resource Locator (URL) for a base (i.e., starting) webpage of the execution run data entity.

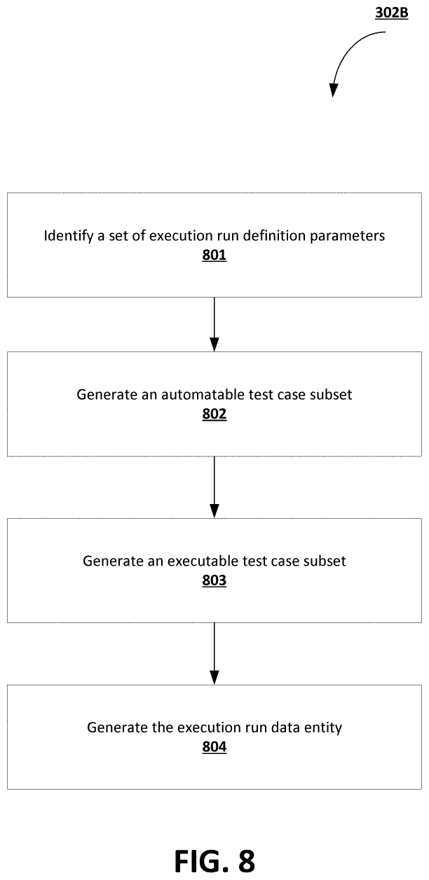

In some embodiments, step/operation 302 may be performed in accordance with the process 302B that is depicted in FIG. 8, which is an example process for generating an execution run data entity that is an automated execution run data entity. The process 302B that is depicted in FIG. 8 begins at step/operation 801 when the web server computing entity 104 identifies a set of execution run definition parameters for the execution run data entity. An execution run definition parameter may define a property related to execution of an execution plan data entity as described by the corresponding execution run data entity. Examples of execution run definition parameters include an execution run automation parameter for the execution run data entity that describes whether the execution run data entity is an automated execution run data entity or a manual execution run data entity; an execution run scheduling parameter for the execution run data entity that describes whether the execution run data entity should be executed once, periodically (e.g., in accordance with a defined periodicity), or in an on-demand manner as demanded by end users; an execution run parallelization parameter for the execution run data entity that describes whether the execution run data entity should be performed sequentially or in parallel; and an execution run web environment parameter for the execution run data entity that describes the Uniform Resource Locator (URL) for a base (i.e., starting) webpage of the execution run data entity.

At step/operation 802, the web server computing entity 104 generates an automatable test case subset of a set of candidate test case data entities for the execution run data entity. The automatable test case subset for an execution run data entity includes each candidate test case data entity that both is in the planned test case subset for an execution plan data entity associated with the execution run data entity and is associated with an automated testing workflow data entity. In other words, the automatable test case subset for an execution run data entity includes each candidate test case data entity that is in the planned test case subset and that is additionally automatable. Aspects of automated testing workflow data entities are described in greater detail below.

In general, an automated testing workflow data entity may describe a sequence of web-based actions that may be executed to generate an automated testing operation associated with a software test that is configured to be executed to achieve a particular software testing objective, such as to exercise a particular program path or to verify compliance with a specific operational requirement. For example, the automated testing workflow data entity may describe a sequence of webpages associated with a software testing operation, where each webpage may in turn be associated with a set of automated testing workflow steps. The sequence of webpages and their associated automated testing workflow steps may then be used to generate automation scripts for the software testing operation, where the automation script may be executed by an execution agent in order to execute the software testing operation and generate a software testing output based at least in part on a result of the execution of the automation script. In some embodiments, an automated testing workflow data entity is determined based at least in part on a test case data entity for the corresponding software testing operation, where the test case data entity may describe data associated with a test case, where the test case may in turn describe a specification of the inputs, execution conditions, testing procedure, and expected results that define a test that is configured to be executed to achieve a particular software testing objective, such as to exercise a particular program path or to verify compliance with a specific operational requirement.

In some embodiments, an automated testing workflow data entity depicts a set of captured page images corresponding to the sequence of webpages associated with the corresponding software testing operation. A captured page image may describe an image file that depicts a screenshot of a corresponding webpage at a particular point in time during a captured sequence of user interactions with the corresponding webpage, where the captured sequence of user interactions may be described by a session data entity that comprises the captured webpage. In some embodiments, prior to loading a subsequent webpage after a current webpage during a session of an end user that includes visiting a sequence of ordered webpages, a software component (e.g., a web browser plugin) generates a screenshot of the current webpage and uses the generated screenshot as a captured page image for the current webpage. As such, in the noted embodiments, the captured page image depicts a visual state of the current webpage after all of the corresponding user interactions associated with the current webpage are executed. In some embodiments, immediately subsequent to successfully loading a current webpage during a session of an end user that includes visiting a sequence of ordered webpages, a software component (e.g., a web browser plugin) generates a screenshot of the current webpage and uses the generated screenshot as a captured page image for the current webpage. As such, in the noted embodiments, the captured page image depicts a visual state of the current webpage before all of the corresponding user interactions associated with the current webpage are executed.

In some embodiments, a webpage associated with an automated testing workflow data entity may be associated with more than one captured page image. In some embodiments, a software component (e.g., a web browser plugin) that is configured to generate session data entities may detect presence of particular expandable interactive page elements within a visited webpage elements within a visited webpage and, upon detection of user interactions configured to expand an expandable interactive page element, generate a captured page image based at least in part on a screenshot of the visited webpage during a visual state in which the expandable interactive page element is in an expanded state. For example, consider a webpage that includes a dropdown menu interactive page element. In the noted example, some captured page images associated with the webpage may depict a visual state of the webpage in which the dropdown menu interactive page element is in a non-expanded state. In some embodiments, upon detection of a user interaction that is configured to expand the dropdown menu interactive page element, a software component (e.g., a web browser plugin) that is configured to generate session data entities may generate a screenshot of a visual state of the webpage in which the dropdown menu interactive page element is in a non-expanded state, and use the generated screenshot to generate an alternative captured page image for the particular webpage. In some embodiments, a software component (e.g., a web browser plugin) that is configured to generate a session data entity may detect transitory display of particular transitory outputs (e.g., notifications) in relation to a visited webpage. In some of the noted embodiments, the noted software component may generate a screenshot of the visited webpage during a transitory display of a particular transitory output (e.g., a particular notification) and use the generated screenshot to generate an alternative captured page image for the particular visited webpage.

In some embodiments, the automated testing workflow data entity may define, for each captured page image associated with an automated testing workflow data entity, a set of automated testing workflow steps. An automated testing workflow step may describe a user action required by a software testing operation associated with a corresponding automated testing workflow data entity, where the user action may be executed with respect to an interactive page element of a webpage associated with a captured page image of the corresponding automated testing workflow data entity. In some embodiments, an automated testing workflow step may be associated with: (i) an image region of the corresponding captured page image that corresponds to the interactive page element for the automated testing workflow step; and (ii) a workflow step action feature element that describes one or more action features of the user action associated with the automated testing workflow step. For example, if an automated testing workflow step corresponds to the user action of selecting a particular button on a particular webpage, the automated testing workflow step may describe data corresponding to an image region of a captured image for the particular webpage that corresponds to (e.g., is defined in relation to) a location of the particular button on the particular webpage. In the noted example, the automated testing workflow step may describe data associated with action features of a user action that may be used to generate a workflow step action feature element for the automated testing workflow step. An action feature of a user action may describe any property of a user action that is configured to change a state and/or a value of an interactive page element within a webpage. Examples of action features for a user action include: (i) a user action type of the user action that may describe a general input mode of user interaction with the interactive page element associated with the user action; (ii) a user input value of the user action that may describe a value provided by the user to an interactive page element; (iii) a user action sequence identifier of the user action that may describe a temporal order of the user action within a set of sequential user actions executed with respect to interactive page elements of a webpage associated with the user action; and (iv) a user action time of the user action that may describe a captured time of the corresponding user action, and/or the like.

At step/operation 803, the web server computing entity 104 generates the executable test case subset for the execution run data entity based at least in part on the automatable test case subset for the execution run data entity. The executable test case subset for an execution run data entity may describe a set of candidate test case data entities that are defined to be executed during an execution of the execution run data entity. In some embodiments, if the execution run data entity is an automated execution run data entity, the executable test case subset for the execution run data entity comprises each test case data entity in the automatable test case subset for the execution run data entity that is not in a skipped test case list for the execution run data entity (e.g., a user-defined skipped test case list for the execution run data entity that may in some embodiments be empty if the user has not specified any test case data entities from the automatable test case subset to skip). In some embodiments, if the execution run data entity is an automated execution run data entity, the executable test case subset for the execution run data entity comprises each test case data entity in the planned test case subset for the test case plan data entity associated with the execution run data entity that is not in a skipped test case list for the execution run data entity (e.g., a user-defined skipped test case list for the execution run data entity that may in some embodiments be empty if the user has not specified any test case data entities from the planned test case subset to skip).

In some embodiments, generating the executable test case subset comprises, in response to determining that the execution run automation parameter describes that the execution run data entity has an automated execution run automation type, generating an automatable test case subset of the planned test case subset, wherein each candidate test case data entity in the automatable test case subset is associated with an automated testing workflow data entity, and filtering the automatable test case subset based at least in part on the skipped test case list to generate the executable test case subset. In some embodiments, generating the executable test case subset comprises, in response to determining that the execution run automation parameter describes that the execution run data entity has a manual execution run automation type, filtering the planned test case subset based at least in part on the skipped test case list to generate the executable test case sub set.

At step/operation 804, the web server computing entity 104 generates the execution run data entity based at least in part on the executable test case subset for the execution run data entity. As described above, the execution run data entity may be configured to enable automated execution of the test case data entities in the executable test case subset. In some embodiments, the execution run data entity is determined based at least in part on at least one of an execution run automation parameter for the execution run data entity that describes whether the execution run data entity is an automated execution run data entity or a manual execution run data entity; an execution run scheduling parameter for the execution run data entity that describes whether the execution run data entity should be executed once, periodically (e.g., in accordance with a defined periodicity), or in an on-demand manner as demanded by end users; an execution run parallelization parameter for the execution run data entity that describes whether the execution run data entity should be performed sequentially or in parallel; and an execution run web environment parameter for the execution run data entity that describes the Uniform Resource Locator (URL) for a base (i.e., starting) webpage of the execution run data entity. In some embodiments, each automation workflow data entity may be associated with one or more environment profiles including up to one default environment profile. In some embodiments, when an execution run data entity is executed, the system first determines whether an environment profile of an automation workflow data entity corresponds to the environment profile of the execution run data entity as defined by execution run web environment parameter for the execution run data entity; if so, then the corresponding environment profile is used to execute the automation workflow data entity. However, if no environment profile for the automation workflow data entity corresponds to the environment profile of the execution run data entity as defined by execution run web environment parameter for the execution run data entity, then the system selects the default environment profile of the automation workflow data entity to execute the automation workflow data entity. In some embodiments, if no environment profile for the automation workflow data entity corresponds to the environment profile of the execution run data entity as defined by execution run web environment parameter for the execution run data entity, and also if the automation workflow data entity does not have a default environment, then executing the automation workflow data entity is skipped and/or a status of “no matching environment profile could be found” is assigned to the automation workflow data entity.

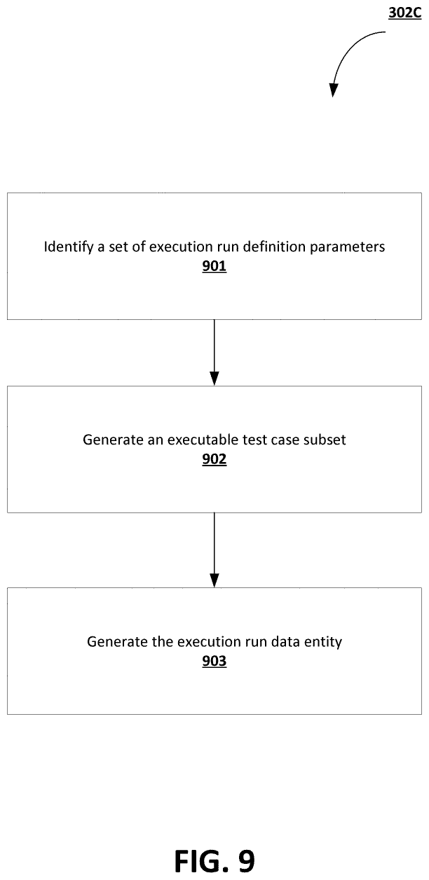

In some embodiments, step/operation 302 may be performed in accordance with the process 302C that is depicted in FIG. 9, which is an example process for generating an execution run data entity that is a manual execution run data entity. The process 302C that is depicted in FIG. 9 begins at step/operation 901 when the web server computing entity 104 identifies a set of execution run definition parameters for the execution run data entity. An execution run definition parameter may define a property related to execution of an execution plan data entity as described by the corresponding execution run data entity. Examples of execution run definition parameters include an execution run automation parameter for the execution run data entity that describes whether the execution run data entity is an automated execution run data entity or a manual execution run data entity; an execution run scheduling parameter for the execution run data entity that describes whether the execution run data entity should be executed once, periodically (e.g., in accordance with a defined periodicity), or in an on-demand manner as demanded by end users; an execution run parallelization parameter for the execution run data entity that describes whether the execution run data entity should be performed sequentially or in parallel; and an execution run web environment parameter for the execution run data entity that describes the Uniform Resource Locator (URL) for a base (i.e., starting) webpage of the execution run data entity.

At step/operation 902, the web server computing entity 104 generates the executable test case subset for the execution run data entity. As described above, the executable test case subset for an execution run data entity may describe a set of candidate test case data entities that are defined to be executed during an execution of the execution run data entity. In some embodiments, if the execution run data entity is an automated execution run data entity, the executable test case subset for the execution run data entity comprises each test case data entity in the automatable test case subset for the execution run data entity that is not in a skipped test case list for the execution run data entity (e.g., a user-defined skipped test case list for the execution run data entity that may in some embodiments be empty if the user has not specified any test case data entities from the automatable test case subset to skip). In some embodiments, if the execution run data entity is an automated execution run data entity, the executable test case subset for the execution run data entity comprises each test case data entity in the planned test case subset for the test case plan data entity associated with the execution run data entity that is not in a skipped test case list for the execution run data entity (e.g., a user-defined skipped test case list for the execution run data entity that may in some embodiments be empty if the user has not specified any test case data entities from the planned test case subset to skip). In some embodiments, generating the executable test case subset comprises, in response to determining that the execution run automation parameter describes that the execution run data entity has an automated execution run automation type, generating an automatable test case subset of the planned test case subset, wherein each candidate test case data entity in the automatable test case subset is associated with an automated testing workflow data entity, and filtering the automatable test case subset based at least in part on the skipped test case list to generate the executable test case subset. In some embodiments, generating the executable test case subset comprises, in response to determining that the execution run automation parameter describes that the execution run data entity has a manual execution run automation type, filtering the planned test case subset based at least in part on the skipped test case list to generate the executable test case subset.

In some embodiments, a test case data entity may be added to the executable test case subset for an automated execution run data entity if the automation stage parameter for the test case data entity is “ready for execution” and the test case data entity is associated with an automated testing workflow data entity. In some embodiments, once a test case data entity having a “ready for execution” automation stage parameter is added to the executable test case subset for an automated test case data entity, then the test case data entity is not removed from the executable test case subset even if the automation stage parameter for the test case data entity is subsequently set to “not ready for execution”; however, in the described scenario, when executing the automated executing run data entity, the test case data entity may be skipped. In some embodiments, a test case data entity may be added to the executable test case subset for a manual execution run data entity if the automation stage parameter for the test case data entity is “ready for execution.” In some embodiments, one objective of maintaining a test case data entity with a changed automation stage parameter within the executable test case subset is to increase traceability of testing record data.

In some embodiments, manual testing based on a manual execution run data entity may be adapted to the skill level of the user(s) who are testing and collecting the execution results. The system can for example adapt in the following ways to the various skillsets: for a beginner user, the system may enable the user to interact with an ordered sequence of individual test case steps in a step-by-step manner and indicate whether each test case step is passed/failed/skipped; for an intermediate the user, the system may enable the user to open documentation data for the test case data entity, manually execute the test case data entity, record result of the manual execution on a test case level, and then proceed to a subsequent test case data entity; and for an advanced user, the system may enable the user to browser short description data for a test case data entity, manually execute the test case data entity, and record the result of the manual execution on a test case level.

At step/operation 903, the web server computing entity 104 generates the execution run data entity based at least in part on the executable test case subset. In some embodiments, the execution run data entity is determined based at least in part on at least one of an execution run automation parameter for the execution run data entity that describes whether the execution run data entity is an automated execution run data entity or a manual execution run data entity; an execution run scheduling parameter for the execution run data entity that describes whether the execution run data entity should be executed once, periodically (e.g., in accordance with a defined periodicity), or in an on-demand manner as demanded by end users; an execution run parallelization parameter for the execution run data entity that describes whether the execution run data entity should be performed sequentially or in parallel; and an execution run web environment parameter for the execution run data entity that describes the Uniform Resource Locator (URL) for a base (i.e., starting) webpage of the execution run data entity.

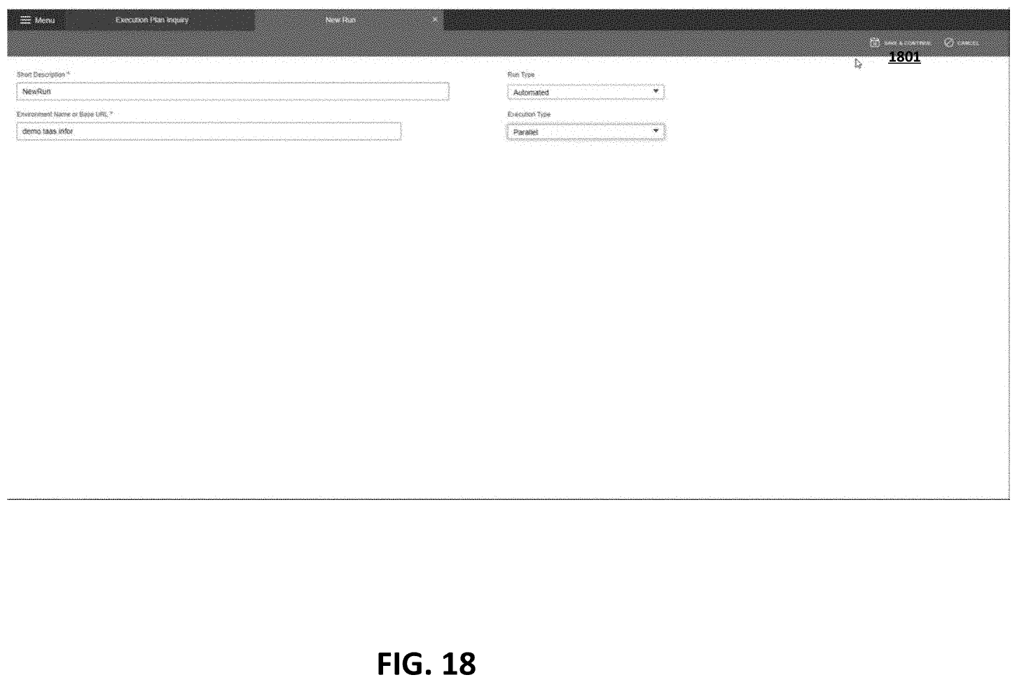

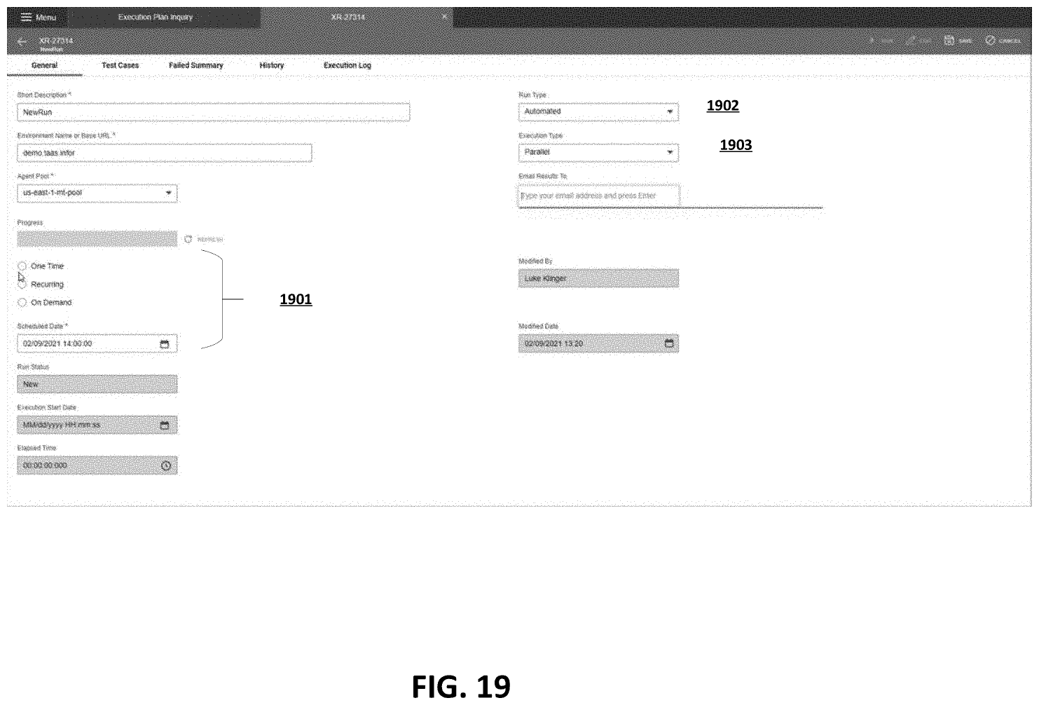

An operational example of generating an execution run data entity is depicted in FIGS. 18-23. The webpages depicted in FIGS. 18-23 may be displayed after the user selects to generate a new execution run data entity using the button 1611 in the webpage of FIG. 16. The webpage depicted in FIG. 18 enables generating a short description, an execution run web environment parameter, an execution run automation parameter, and an execution run parallelization parameter for the execution run data entity. After providing the fields corresponding to the short description, the execution run web environment parameter, the execution run automation parameter, and the execution run parallelization parameter, the user may select the button 1801 to generate the execution run data entity. This leads to display of the webpage platform that is associated with the webpages depicted in FIGS. 19-23.

In particular, the webpage depicted in FIG. 19 enables providing a range of features for the execution run data entity, including a short description of the execution run data entity, an execution run web environment parameter of the execution run data entity, an execution run agent pool parameter of the execution run data entity, an execution run scheduling parameter 1901 of the execution run data entity, an execution run automation parameter 1902 of the execution run data entity, an execution run parallelization parameter 1903 of the execution run data entity, and a result recipient email address for the execution run data entity. The webpage depicted in FIG. 19 further enables viewing the execution run status, the execution run start date, the execution run elapsed time, the execution run latest modifier user profile, and the latest modification date of the execution run data entity.

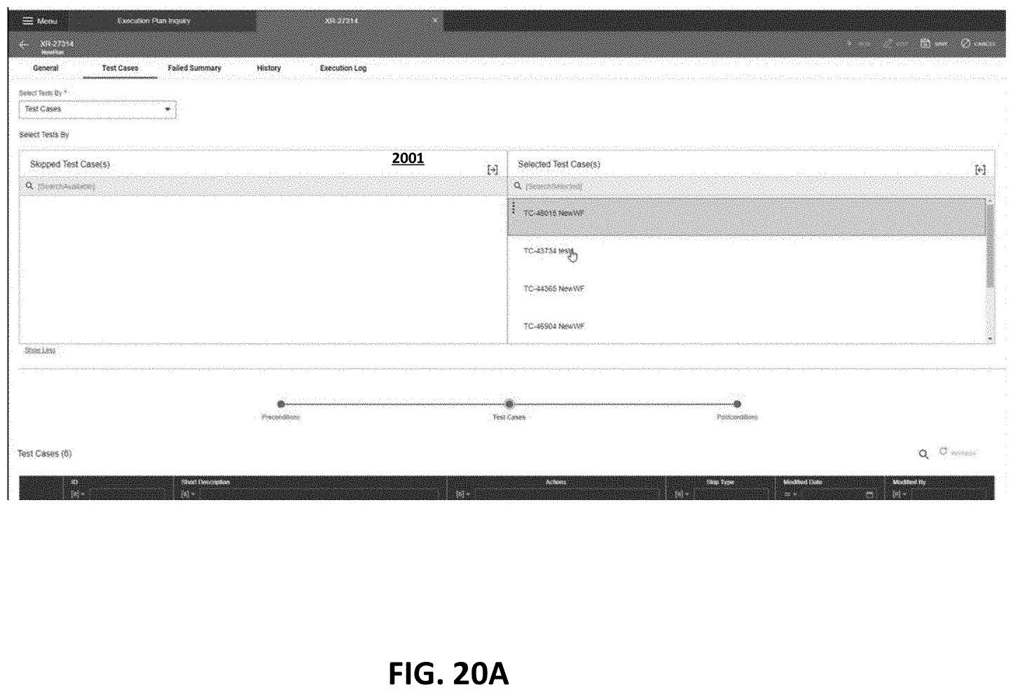

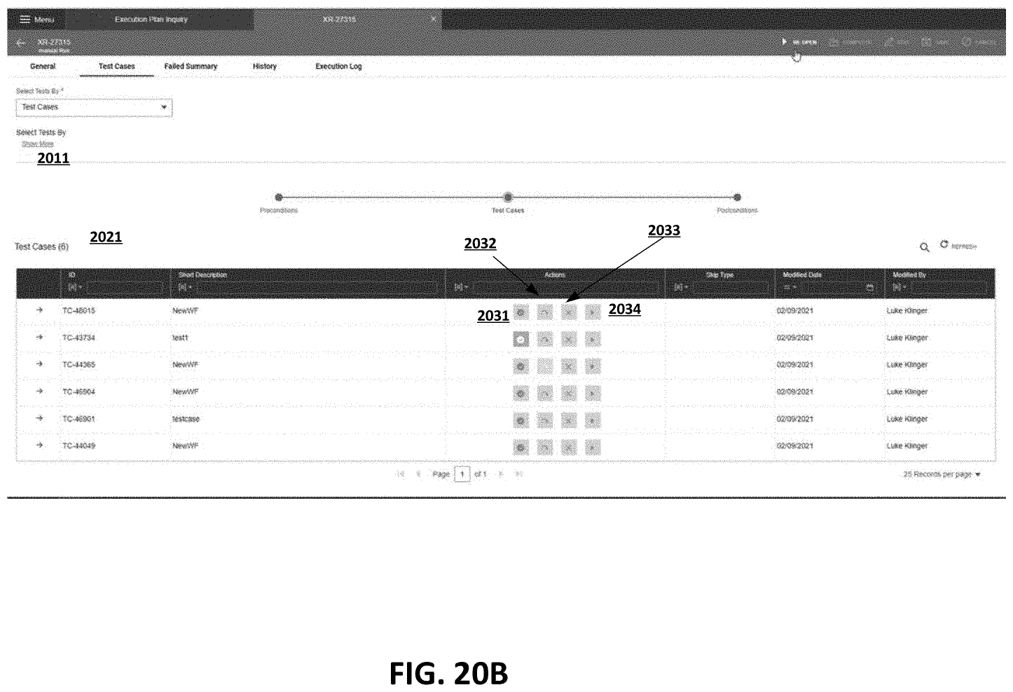

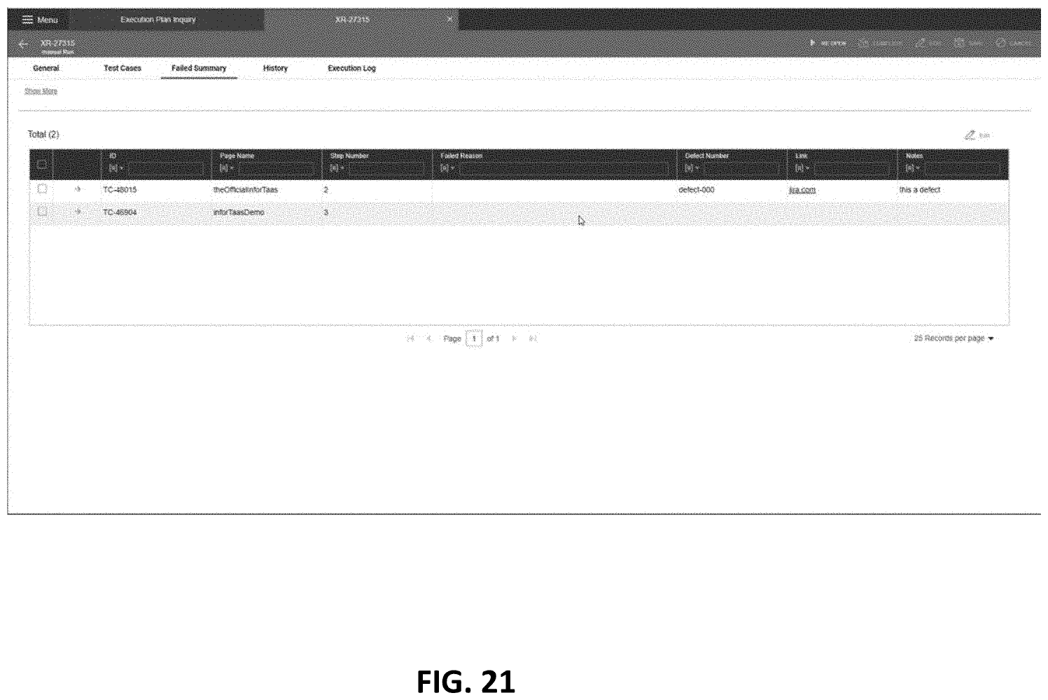

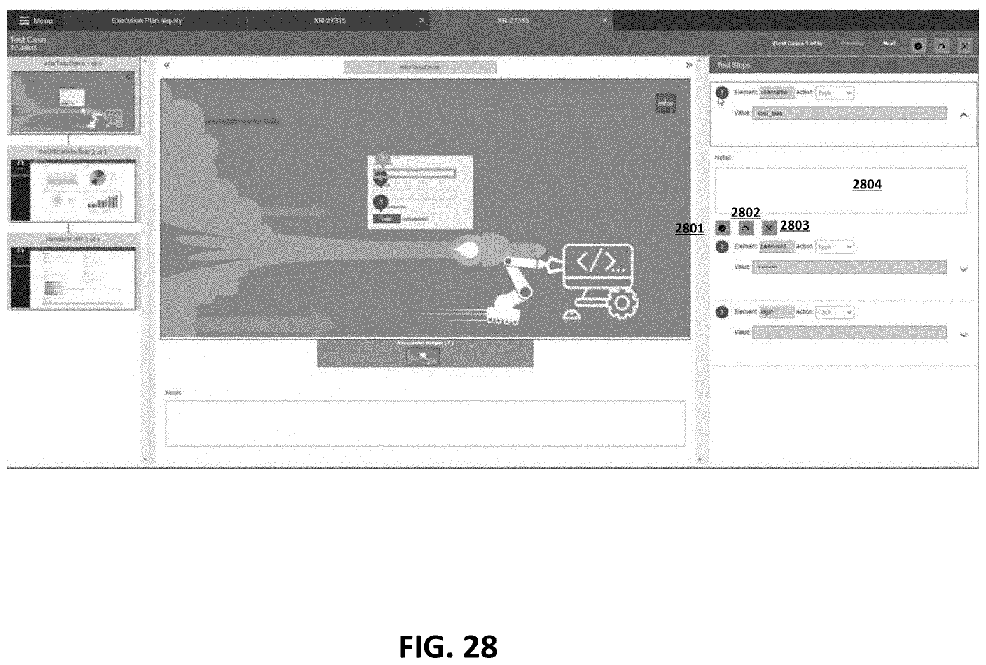

In addition, the webpages depicted in FIGS. 20A-20B enable modifying the executable test case subset for the execution run data entity. In particular, the webpage that is depicted in FIG. 20A enables modifying the executable test case subset for an automated execution run data entity by defining a skipped test case list 2001, while the webpage that is depicted in FIG. 20B enables (in addition to modifying the executable test case subset using the webpage element 2011) defining test case result indicators for each test case data entity in the executable test case subset 2021. For example, for the first test case data entity in the executable test case subset, button 2031 enables setting an affirmative test case result indicator for the test case data entity, button 2032 enables setting a negative test case result indicator for the test case data entity, button 2033 enables skip the test case data entity, and button 2034 enables viewing the test case steps for the test case data entity which in turn enables setting test case step result indicators for those test case steps. In some embodiments, user selection of the button 2034 depicts the webpage that is depicted in FIG. 28, which enables recording test case results on a test case step level. For example, as depicted, for the selected test case step, button 2801 enables setting an affirmative test case step result indicator for the test case step, button 2802 enables setting a negative test case step result indicator for the test case step, button 2803 enables skipping the test case step, and panel 2804 enables typing test case step result notes for manual execution of the test case step. Furthermore, the webpage that is depicted in FIG. 21 enables viewing and modifying the failure history of the execution run data entity. For each execution failure, the webpage depicts a corresponding test case identifier, a webpage identifier, a test case step identifier, a failure reason, a defect number, a defect link, and any notes related to the execution failure. In some embodiments, when an execution failure has previously occurred, then the system may supply failure information (e.g., at least one of a failure reason, a defect number, a defect link, and any notes) related to the execution failure as default failure information for the previously-occurred execution failure.

In some embodiments, only users who have permission to access an execution run web environment are allowed to view the detailed test results for an execution run data entity that is executed with respect to the noted execution run web environment. In some embodiments, when two or more users (e.g., a team of users) are working on a manual execution run data entity and/or a worksheet execution run data entity, a user can view the latest test results provided by other users when the user views a test result page associated with the a manual execution run data entity and/or the worksheet execution run data entity (e.g., the test result page of FIG. 20B for a manual execution run data entity).

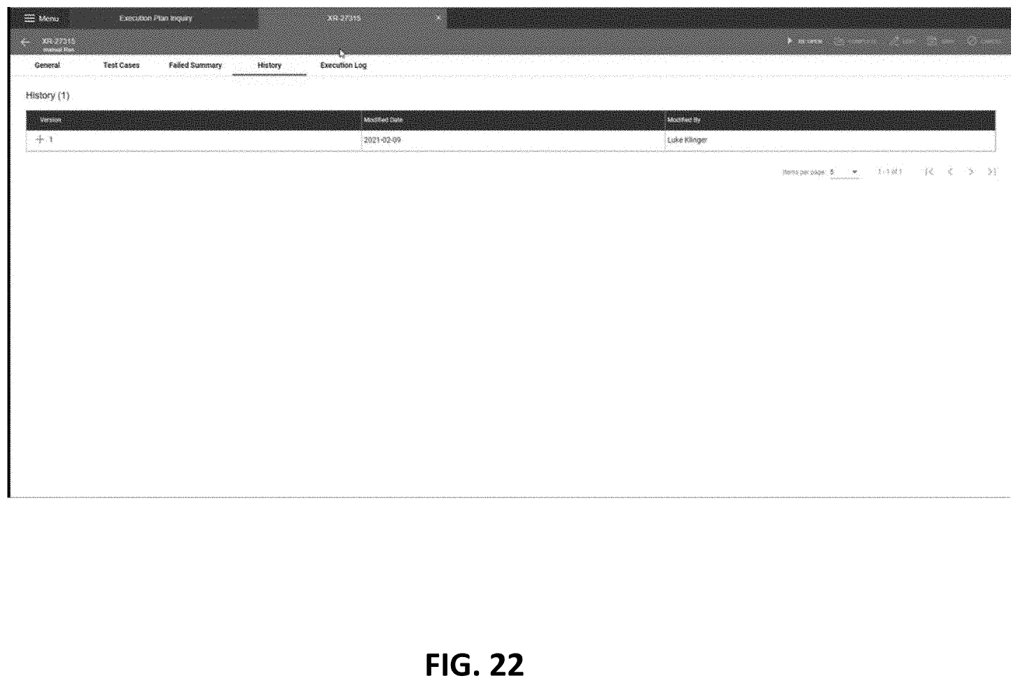

Moreover, the webpage that is depicted in FIG. 22 enables viewing the revision history for the execution run data entity. For each recorded modification, the webpage depicts a modifier user profile, a modification time, and a description of all changes made as a result of the noted recorded modification.

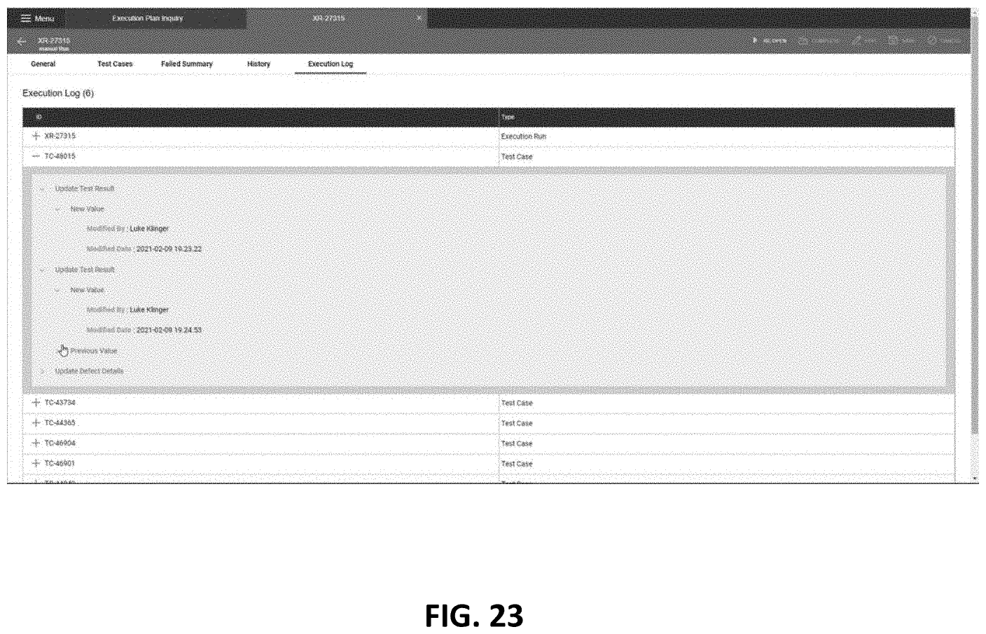

Finally, the webpage that is depicted in FIG. 23 enables viewing the execution log for the execution run data entity. For each recorded execution of the execution run data entity, the webpage depicts any execution results. For each recorded modification of the execution run data entity, the webpage depicts a modifier user profile, a modification time, and a description of all changes made as a result of the noted recorded modification.

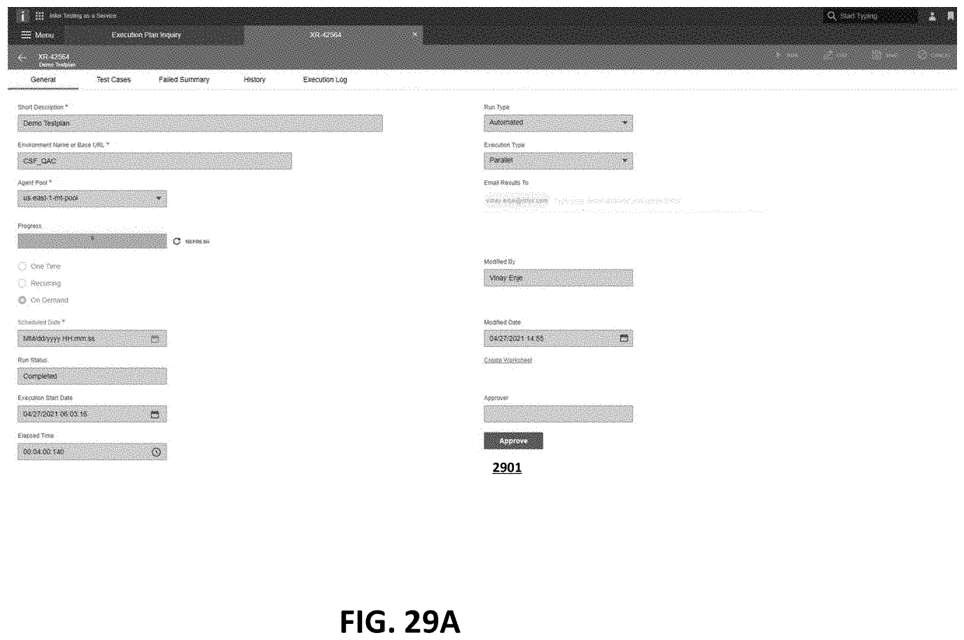

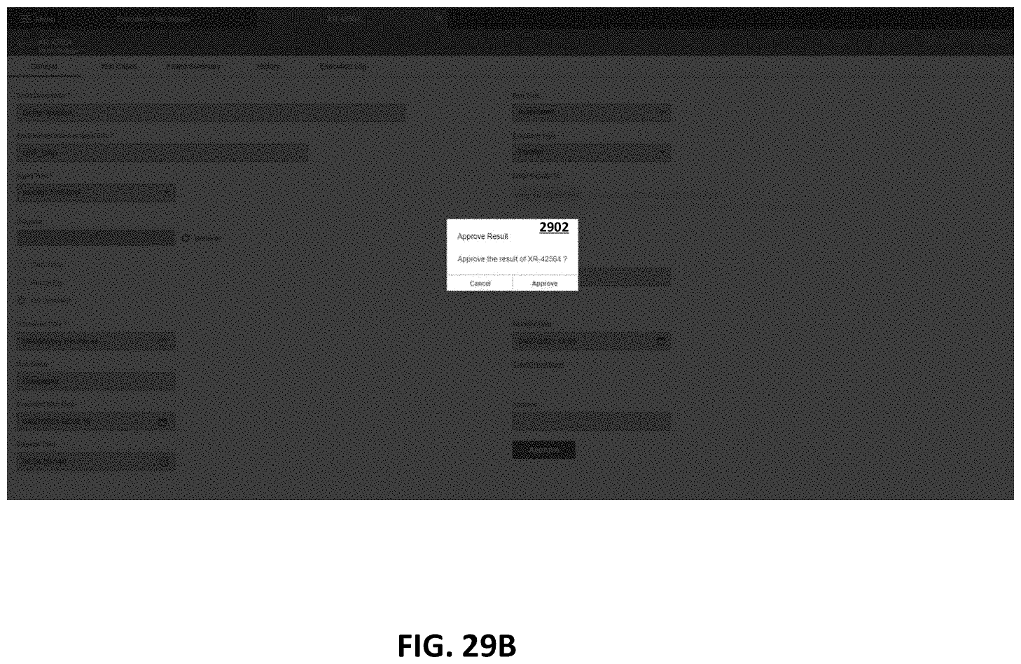

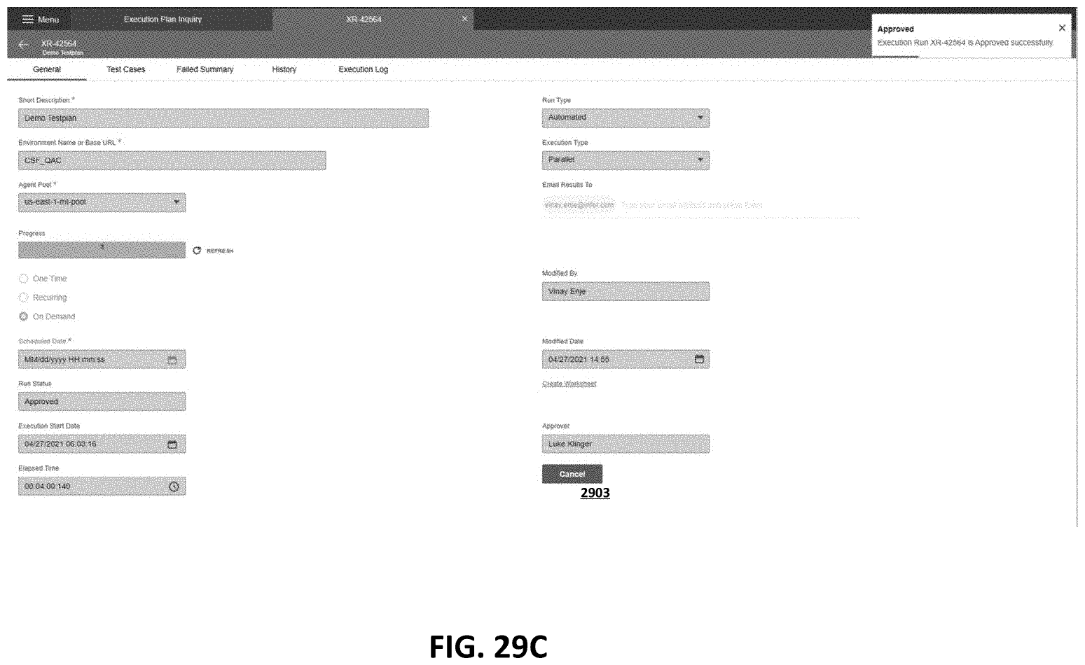

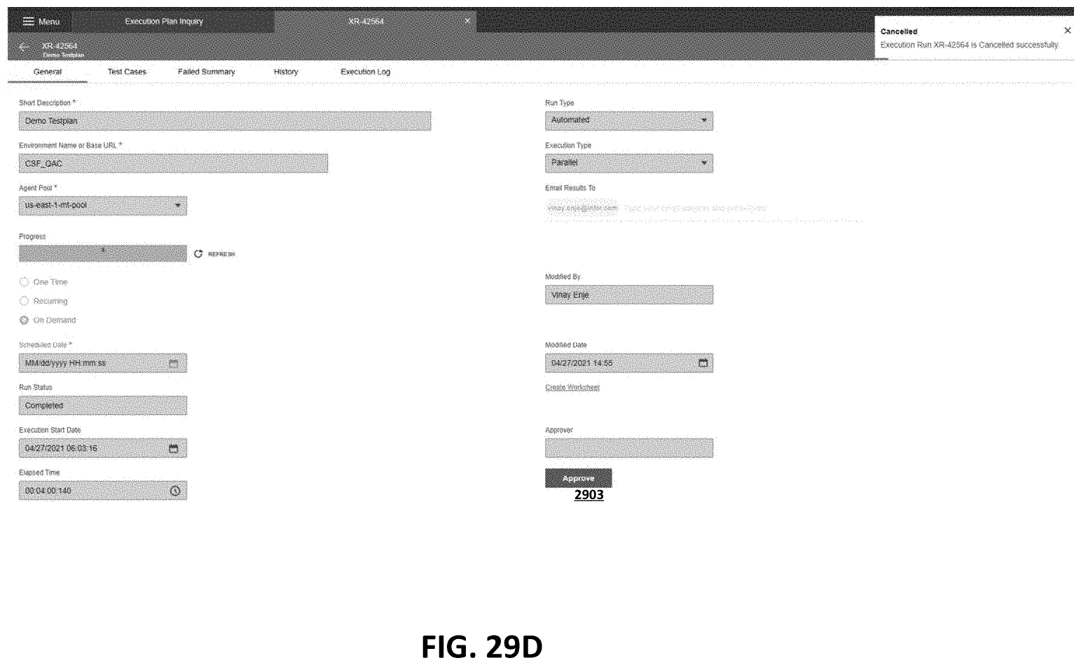

In some embodiments, once executed, the results of an execution run data entity may be approved and the results of an approved execution run data entity may be cancelled. For example, as depicted in FIGS. 29A-29B, results of an execution run data entity may be approved via selecting the button 2901 and confirming the approval via the panel 2902. Moreover, as depicted in FIGS. 29C-29D, results of an approved execution run data entity may be cancelled via selecting the button 2903.

Returning to FIG. 3, at step/operation 303, the web server computing entity 104 enables performing one or more software testing operations based at least in part on the execution run data entity. In some embodiments, given an automated execution run data entity, performing software testing operations includes enabling an end user to cause a testing computing entity to execute the execution run data entity in accordance with the execution run parallelization parameter, the execution run scheduling parameter, and the execution run web environment. In some embodiments, given a manual execution run data entity, performing software testing operations includes enabling the end user to modify the execution run data entity by defining each manual test case result indicator for at least one candidate test case data entity in the executable test case subset. In some embodiments, given a manual execution run data entity, performing software testing operations includes enabling the end user to modify the execution run data entity by defining each manual test case step result indicator for at least one test case step in a set of test case steps for the executable test case subset. In some embodiments, given an implicit execution run data entity that is generated based at least in part on a worksheet execution run data entity, the execution run data entity is executed based at least in part on whether the execution run data entity is an automated execution run data entity or a manual execution run data entity.

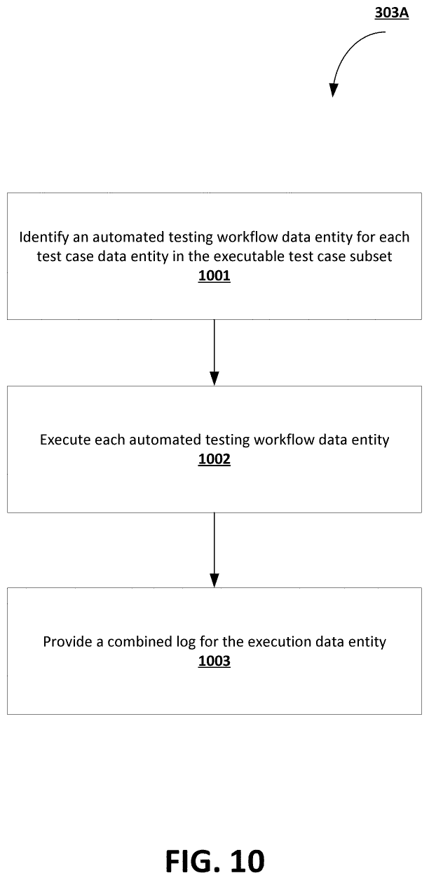

In some embodiments, step/operation 303 may be performed in accordance with the process 303A that is depicted in FIG. 10, which is an example process for generating a combined execution log for an execution run data entity that is an automated execution run data entity. The process 303A that is depicted in FIG. 10 begins at step/operation 1001 when the web server computing entity 104 identifies an automated testing workflow data entity for each test case data entity that is in the executable test case subset for the execution run data entity. As described above, an automated testing workflow data entity may describe a sequence of web-based actions that may be executed to generate an automated testing operation associated with a software test that is configured to be executed to achieve a particular software testing objective, such as to exercise a particular program path or to verify compliance with a specific operational requirement. For example, the automated testing workflow data entity may describe a sequence of webpages associated with a software testing operation, where each webpage may in turn be associated with a set of automated testing workflow steps. The sequence of webpages and their associated automated testing workflow steps may then be used to generate automation scripts for the software testing operation, where the automation script may be executed by an execution agent in order to execute the software testing operation and generate a software testing output based at least in part on a result of the execution of the automation script. In some embodiments, an automated testing workflow data entity is determined based at least in part on a test case data entity for the corresponding software testing operation, where the test case data entity may describe data associated with a test case, where the test case may in turn describe a specification of the inputs, execution conditions, testing procedure, and expected results that define a test that is configured to be executed to achieve a particular software testing objective, such as to exercise a particular program path or to verify compliance with a specific operational requirement.

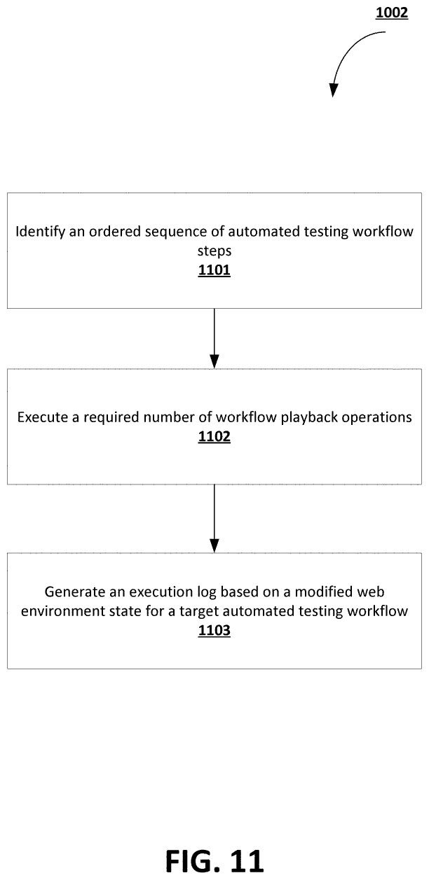

At step/operation 1002, the web server computing entity 104 executes each automated testing workflow data entity to generate an execution log for the automated testing workflow data entity. In some embodiments, executing an automated testing workflow data entity comprises executing all automated testing steps associated with the automated testing workflow data entity. In some embodiments, step/operation 1102 may be performed in accordance with the process that is depicted in FIG. 11, which is an example process for executing operations corresponding to an automated testing workflow data entity to generate an execution log for the automated testing workflow data entity.

The process that is depicted in FIG. 11 begins at step/operation 1101 when the web server computing entity 104 identifies an ordered sequence of automated testing workflow steps for the automated testing workflow data entity. In some embodiments, the ordered sequence of automated testing workflow steps for the automated testing workflow data entity include all of the automated testing workflow steps of the automated testing workflow data entity as ordered based both on the ordering of automated testing workflow steps within captured page images and ordering of webpages associated with captured page images.

For example, consider an automated testing workflow data entity that is associated with the following sequence of webpages W1→W2→W3, where W1 is associated with the following sequence of automated testing workflow steps S1→S2→S3, W2 is associated with the following sequence of automated testing workflow steps S4→S5, and W3 is associated with the following sequence of automated testing workflow steps S6→S7→S8→S9. In this example, the ordered sequence of automated testing workflow steps for the exemplary automated testing workflow data entity may include: S1→S2→S3→S4→S5→S6→S7→S8→S9.

As described above, an automated testing workflow data entity may describe a sequence of web-based actions that may be executed to generate an automated testing operation associated with a software test that is configured to be executed to achieve a particular software testing objective, such as to exercise a particular program path or to verify compliance with a specific operational requirement. For example, the automated testing workflow data entity may describe a sequence of webpages associated with a software testing operation, where each webpage may in turn be associated with a set of automated testing workflow steps. The sequence of webpages and their associated automated testing workflow steps may then be used to generate automation scripts for the software testing operation, where the automation script may be executed by an execution agent in order to execute the software testing operation and generate a software testing output based at least in part on a result of the execution of the automation script. In some embodiments, an automated testing workflow data entity is determined based at least in part on a test case data entity for the corresponding software testing operation, where the test case data entity may describe data associated with a test case, where the test case may in turn describe a specification of the inputs, execution conditions, testing procedure, and expected results that define a test that is configured to be executed to achieve a particular software testing objective, such as to exercise a particular program path or to verify compliance with a specific operational requirement.

In some embodiments, the automated testing workflow data entity may define, for each captured page image associated with an automated testing workflow data entity, a set of automated testing workflow steps. An automated testing workflow step may describe a user action required by a software testing operation associated with a corresponding automated testing workflow data entity, where the user action may be executed with respect to an interactive page element of a webpage associated with a captured page image of the corresponding automated testing workflow data entity. In some embodiments, an automated testing workflow step may be associated with: (i) an image region of the corresponding captured page image that corresponds to the interactive page element for the automated testing workflow step; and (ii) a workflow step action feature element that describes one or more action features of the user action associated with the automated testing workflow step. For example, if an automated testing workflow step corresponds to the user action of selecting a particular button on a particular webpage, the automated testing workflow step may describe data corresponding to an image region of a captured image for the particular webpage that corresponds to (e.g., is defined in relation to) a location of the particular button on the particular webpage. In the noted example, the automated testing workflow step may describe data associated with action features of a user action that may be used to generate a workflow step action feature element for the automated testing workflow step. An action feature of a user action may describe any property of a user action that is configured to change a state and/or a value of an interactive page element within a webpage. Examples of action features for a user action include: (i) a user action type of the user action that may describe a general input mode of user interaction with the interactive page element associated with the user action; (ii) a user input value of the user action that may describe a value provided by the user to an interactive page element; (iii) a user action sequence identifier of the user action that may describe a temporal order of the user action within a set of sequential user actions executed with respect to interactive page elements of a webpage associated with the user action; and (iv) a user action time of the user action that may describe a captured time of the corresponding user action, and/or the like.

At step/operation 1102, the web server computing entity 104 executes a required number of workflow playback operations based at least in part on the ordered sequence until a terminal workflow playback operation that is associated with a target automated testing workflow step that is a first automated testing workflow step with a negative success indicator. In some embodiments, the web server computing entity 104 performs a workflow playback operation for each automated testing workflow step until a first automated testing workflow step that is associated with an interactive page element that cannot be located within a corresponding webpage and/or with respect to which a captured user interaction associated with the automated testing workflow step cannot successfully be performed.

In general, a workflow playback operation may describe an operation that is configured to perform a captured user action associated with a corresponding automated testing workflow step within a web environment of the automated testing workflow data entity that comprises the corresponding automated testing workflow step. In some embodiments, executing a workflow playback operation comprises: (i) identifying a workflow simulation web environment for a webpage associated with the automated testing workflow step for the workflow playback operation; (ii) generating a modified web environment state for the automated testing workflow step by modifying a web environment state of the workflow simulation web environment based at least in part on a captured user interaction for the automated testing workflow step; and (iii) generating the success indicator for the workflow playback operation based at least in part on the modified web environment state for the automated testing workflow step.

As used herein in relation to workflow playback operations, the success indicator may be a value that is configured to describe whether a corresponding workflow playback operation associated with a corresponding automated testing workflow step has successfully executed a captured user interaction associated with the corresponding automated testing workflow step with respect to a web environment defined by a corresponding automated testing workflow data entity that comprises the corresponding automated testing workflow step. In some embodiments, if a corresponding workflow playback operation associated with a corresponding automated testing workflow step has successfully executed a captured user interaction associated with the corresponding automated testing workflow step with respect to a web environment defined by a corresponding automated testing workflow data entity that comprises the corresponding automated testing workflow step, then the success indicator for the corresponding workflow playback operation may be a positive value. In some embodiments, if a corresponding workflow playback operation associated with a corresponding automated testing workflow step has not successfully executed a captured user interaction associated with the corresponding automated testing workflow step with respect to a web environment defined by a corresponding automated testing workflow data entity that comprises the corresponding automated testing workflow step, then the success indicator for the corresponding workflow playback operation may be a negative value. In some embodiments, the success indicator for a workflow playback operation that is associated with an automated testing workflow step may be negative if one of the following conditions is satisfied: (i) no interactive page element is detected at a page region of a corresponding webpage that is determined in accordance with the element location data for the automated testing workflow step; or (ii) an interactive page element is detected at a page region of a corresponding webpage that is determined in accordance with the element location data for the automated testing workflow step, but the detected interactive page element has an element type that is inconsistent with an element type of an interactive page element for the corresponding automated testing workflow step as determined in accordance with the element type data for the automated testing workflows step.

At step/operation 1103, the web server computing entity 104 generates the execution log based at least in part on the modified web environment state for the target automated testing workflow step that is associated with the terminal workflow playback operation. The execution log may describe at least one success indicator associated with a workflow playback operation of the required number of workflow playback operations. In some embodiments, the execution log describes an affirmative execution log field for each automated testing workflow step that is associated with the required number of workflow playback operations other than the terminal workflow playback operation. In some embodiments, the execution log describes a negative execution log field for the target automated testing workflow step that is associated with terminal workflow playback operation. In some embodiments, user selection of the negative execution log causes generating user interface data for a workflow step action feature element that is associated with the target automated testing workflow step. In some embodiments, modifying the target automated testing workflow step can be performed via user interaction with the workflow step action feature element.

Returning to FIG. 10, at step/operation 1003, the web server computing entity 104 provides the combined log for the execution run data entity based at least in part on each execution log for an automated testing workflow data entity that is associated with the execution run data entity. In some embodiments, the web server computing entity 104 combines each execution log for an automated testing workflow data entity that is associated with the execution run data entity to generate the combined execution log for the execution run data entity. Subsequent to generating the combined execution log, the web server computing entity 104 may provide the combined execution log for access by a set of end users. In some embodiments, combined execution logs are only provided subsequent to manual execution of manual execution run data entities.

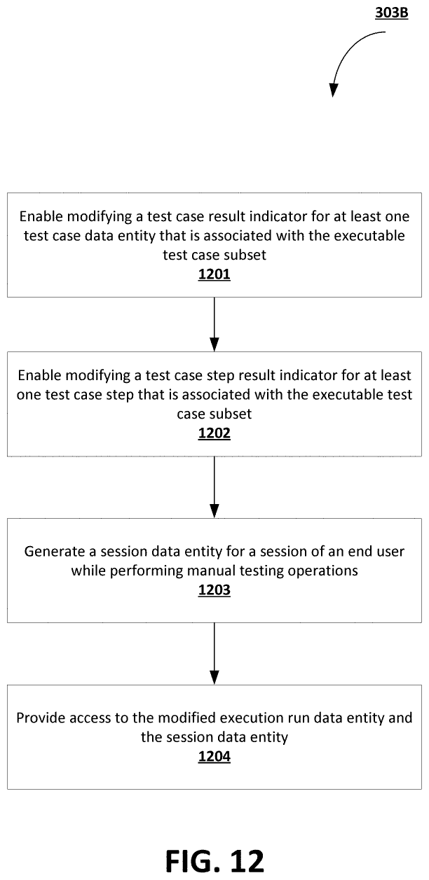

In some embodiments, step/operation 303 can be performed in accordance with the process 303B that is depicted in FIG. 12, which is an example process for generating a modified execution run data entity and a session data entity for an execution run data entity that is a manual execution run data entity. The process 303B that is depicted in FIG. 12 begins at step/operation 1201 when the web server computing entity 104 enables modifying a test case result indicator (i.e., describing whether a corresponding test case data entity was successfully performed during a manual testing operation) for at least one test case data entity that is associated with the executable test case subset for the execution run data entity.

At step/operation 1202, the web server computing entity 104 enables modifying a test case step result indicator (i.e., describing whether a corresponding test case data entity was successfully performed during a manual testing operation) for at least one test case step of a test case data entity that is associated with the executable test case subset for the execution run data entity. The set of test case steps associated with the executable test case subset for an execution run data entity include all test case steps for all test case data entities that are in the executable test case subset for the execution run data entity.

At step/operation 1203, the web server computing entity 104 optionally generates a session data entity that describes a session of an end user while performing manual testing operations corresponding to the execution run data entity. In some embodiments, the web server computing entity 104 utilizes one or more web browser extensions to capture user interactions with an ordered sequence of webpages and uses captured images corresponding to the ordered sequence and the captured user interactions to generate the session data entity.

In some embodiments, the session data entity may describe recorded/captured data associated with a set of user interactions in relation to a set of webpages. For example, the session data entity may describe that an end user loads a first webpage, enters a text input in a first designated textbox on the first webpage, selects a first designated checkbox on the first webpage, selects a first designated button on the first webpage to proceed to a second webpage, selects a set of items from a first designated list box on the second webpage, selects a first designated radio button from a first designated set of related radio buttons on the second webpage, and selects a second designated button on the second webpage. In the noted example, a software component (e.g., a web browser extension) may be configured to detect and record a set of user interactions by an end user across the two webpages in order to generate the session data entity. Thus, the session data entity may describe: (i) a sequence of webpages across which user interactions have been captured, and (ii) for each webpage of the sequence of webpages, a set of user interactions performed in relation to the noted webpage. For example, for the exemplary session data entity described above, the session data entity may describe: (i) a sequence of webpages that describes that the first webpage was visited first and the second webpage was subsequently visited; (ii) for the first webpage, the user interactions corresponding to entering a text input in the first designated textbox on the first webpage, selecting the first designated checkbox on the first webpage, and selecting the first designated button on the first webpage; and (iii) for the second webpage, the user interactions corresponding to selecting the first designated radio button from the first designated set of related radio buttons on the second webpage and selecting the second designated button on the second webpage. In some embodiments, the session data entity comprises (a) an ordered sequence of a plurality of captured page images that (i) were captured during the session, and (ii) correspond to a plurality of webpages visited by the end user during the session, and (b) a plurality of captured user interactions performed by the end user while interacting with the plurality of webpages.

A captured page image may describe an image file that depicts a screenshot of a corresponding webpage at a particular point in time during a captured sequence of user interactions with the corresponding webpage, where the captured sequence of user interactions may be described by a session data entity that comprises the captured webpage. In some embodiments, prior to loading a subsequent webpage after a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage after all of the corresponding user interactions associated with the current webpage are performed. In some embodiments, immediately subsequent to successfully loading a current webpage during a session of an end user that includes visiting a sequence of ordered webpages, a software component (e.g., a web browser extension) generates a screenshot of the current webpage and uses the generated screenshot as a captured page image for the current webpage. As such, in the noted embodiments, the captured page image depicts a visual state of the current webpage before all of the corresponding user interactions associated with the current webpage are performed.

While various embodiments of the present invention describe session data entities in which a visited webpage is associated with a single captured page image, a person of ordinary skill in the relevant technology will recognize that in some embodiments a visited webpage may be associated with two or more captured page images. In some embodiments, a software component (e.g., a web browser extension) that is configured to generate a session data entities may detect presence of particular expandable interactive page elements within a visited webpage elements within a visited webpage and, upon detection of user interactions configured to expand an expandable interactive page element, generate a captured page image based at least in part on a screenshot of the visited webpage during a visual state in which the expandable interactive page element is in an expanded state. For example, consider a webpage that includes a dropdown menu interactive page element. In the noted example, some captured page images associated with the webpage may depict a visual state of the webpage in which the dropdown menu interactive page element is in a non-expanded state. In some embodiments, upon detection of a user interaction that is configured to expand the dropdown menu interactive page element, a software component (e.g., a web browser extension) that is configured to generate session data entities may generate a screenshot of a visual state of the webpage in which the dropdown menu interactive page element is in a non-expanded state, and use the generated screenshot to generate an alternative captured page image for the particular webpage. In some embodiments, a software component (e.g., a web browser extension) that is configured to generate a session data entities may detect transitory display of particular transitory outputs (e.g., notifications) in relation to a visited webpage. In some of the noted embodiments, the noted software component may generate a screenshot of the visited webpage during a transitory display of a particular transitory output (e.g., a particular notification) and use the generated screenshot to generate an alternative captured page image for the particular visited webpage.

A captured user interaction may describe a recorded/captured user action with respect to a segment of a webpage, where the captured user interaction may be described by a session data entity corresponding to a recorded/captured session that included performing the corresponding user action associated with the captured user interaction. In some embodiments, a captured user interaction describes: (i) an associated interactive page element within a corresponding webpage with respect to which the corresponding user action was performed during the recorded/captured session; (ii) a user action type of the corresponding user action with respect to the associated interactive page element within the corresponding webpage; and (iii) if the corresponding user action type of the corresponding user action requires inputting a user input value, the user input value entered as part of the corresponding user action associated with the captured user interaction. For example, consider a recorded/captured session that included the user action of selecting a button within a webpage. In the noted example, the captured user interaction corresponding to the noted action may describe: (i) the button as the interactive page element corresponding to the captured user interaction; and (ii) (i.e., clicking) as the user action type of the captured user interaction. As another example, consider a recorded/captured session that included the user action of typing “pshoghi” into a username textbox. In the noted example, the captured user interaction corresponding to the noted user action may describe: (i) the username textbox as the interactive page element corresponding to the captured user interaction; (ii) typing (i.e., inputting text) as the user action type corresponding to the captured user interaction; and (iii) because the user action type of typing requires a user input value, the text input value “pshoghi” as the user input value for the captured user interaction. Other examples of qualified user actions that can be associated with captured user interactions include: drag and drop actions, opening/closing tabs within a browser, file upload/download, browser actions (e.g., refreshing, clicking on a “back” button to get a previously-visited page), navigating to a new webpage, hotkey events (e.g., pressing at least one ctrl+A, ctrl+C, ctrl+Z, etc.), and/or the like. In some embodiments, opening a tab can be performed in multiple ways. During a sequence of events within a session, the user may click to manually navigate to another web site via another browser tab, or the application itself may launch another web site via another browser tab.

In some embodiments, a captured user interaction is associated with (i) a captured page image; (ii) an interactive page element; and (ii) a set of action features. The captured page image for a captured user interaction may describe an image of a corresponding webpage with respect to which a user action corresponding to the captured user interaction is performed, while an interactive page element may describe an element (e.g., an interactive page element, an HTML element, and/or the like) of the corresponding webpage, where the user action corresponding to the captured user interaction is performed exclusively by changing a state and/or a value of the particular element. An action feature of a captured user interaction may describe any property of a user action intended to change a state and/or a value of an interactive page element, where the user action is recorded/captured using a captured user interaction in a session data entity. Examples of action features for a captured user interaction include (i) a user action type of a user action associated with the captured user interaction that may describe a general mode of user interaction with an interactive page element which may be defined based at least in part on an interactive page element type of the interactive page element; (ii) a user input value of a user action associated with the captured user interaction that may describe a finalized (rather than intermediate) value of a user action with respect to an interactive page element; (iii) a user action sequence identifier of a user action associated with the captured user interaction that may describe a temporal order of the user action within a set of sequential user actions performed with respect to interactive page elements of a webpage associated with the user action; (iv) a user action time of a user action associated with the captured user interaction that may describe a captured time of the corresponding user action, and/or the like.

As described above, the user input value of a captured user interaction may describe a finalized rather than an intermediate value of a user action associated with the user input value. This means that if, during the course of a session, an end user performs multiple conflicting actions with respect to an interactive page element, then only the final user action will be used to generate the user input value for a captured user inaction associated with the noted interactive page element. For example, consider a session during which an end user first selects a checkbox and then unselects the selected checkbox. In the noted example, a component (e.g., a web browser extension) that is configured to generate a session data entity for the session may not generate a captured user interaction for the noted conflicting actions with respect to the checkbox interactive page element. As another example, consider a session during which an end user first types “pshoghg” into a text box, then removes the final character of the noted text input and instead types an “i” character. In the noted example, a component (e.g., a web browser extension) that is configured to generate a session data entity for the session may generate a captured user interaction with respect to the text box that is associated with the user input value “pshoghi.” As yet another example, consider a session during which an end user first types “pshoghi” into a text box, then at a subsequent time prior to loading a subsequent webpage removes “pshoghi” from the text box and types “jbrown” instead. In the noted example, a component (e.g., a web browser extension) that is configured to generate a session data entity for the session may generate a captured user interaction with respect to the text box that is associated with the user input value “jbrown.” In some embodiments, the web session computing entity the web server computing entity 104 is not a key logger and captures the totality of the final text entered by the user.

At step/operation 1204, the web server computing entity 104 provides access to the modified execution run data entity and the session data entity. In some embodiments, the execution run data entity describes, for each test case data entity associated with the execution run data entity, a manual test case result indicator. In some embodiments, the execution run data entity describes, for each test case step associated with the execution run data entity, a manual test case step result indicator. In some embodiments, enabling the end user to perform one or more software testing operations based at least in part on the execution run data entity comprises, in response to determining that the execution run automation parameter describes that the execution run data entity has a manual execution run automation type, for each candidate test case data entity in the executable test case subset, generating a session data entity and providing access to the session data entity as part of test verification data for the execution run data entity.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for generating an execution run data entity based at least in part on an execution plan data entity, the computer-implemented method comprising:
identifying, using one or more processors, a set of execution run definition parameters for the execution run data entity, wherein the set of execution run definition parameters comprise an execution run automation parameter for the execution run data entity;
generating, using the one or more processors, an executable test case subset of a set of candidate test case data entities for the execution run data entity, wherein the executable test case subset for the execution run data entity is determined by filtering a planned test case subset for the execution plan data entity based at least in part on the execution run automation parameter and a skipped test case list for the execution run data entity;
generating, using the one or more processors, the execution run data entity based at least in part on the executable test case subset and the set of execution run definition parameters; and
enabling, using the one or more processors, an end user to perform one or more software testing operations based at least in part on the execution run data entity.

2. The computer-implemented method of claim 1, wherein generating the executable test case subset comprises:
in response to determining that the execution run automation parameter describes that the execution run data entity has an automated execution run automation type:
generating an automatable test case subset of the planned test case subset, wherein each candidate test case data entity in the automatable test case subset is associated with an automated testing workflow data entity, and
filtering the automatable test case subset based at least in part on the skipped test case list to generate the executable test case subset.

3. The computer-implemented method of claim 1, wherein generating the executable test case subset comprises:
in response to determining that the execution run automation parameter describes that the execution run data entity has a manual execution run automation type:
filtering the planned test case subset based at least in part on the skipped test case list to generate the executable test case subset.

4. The computer-implemented method of claim 1, wherein enabling the end user to perform one or more software testing operations based at least in part on the execution run data entity comprises:
in response to determining that the execution run automation parameter describes that the execution run data entity has an automated execution run automation type:
enabling the end user to cause a testing computing entity to execute the execution run data entity.

5. The computer-implemented method of claim 4, wherein:
the set of execution run definition parameters comprise an execution run serial execution parameter, an execution run parallelization parameter for the execution run data entity, an execution run scheduling parameter for the execution run data entity, and an execution run web environment parameter for the execution run data entity, and
enabling the end user to cause the testing computing entity to execute the execution run data entity comprises enabling the end user to cause the testing computing entity to execute the execution run data entity in accordance with the execution run parallelization parameter, the execution run scheduling parameter, and the execution run web environment.

6. The computer-implemented method of claim 4, wherein executing the execution run data entity comprises:
for each candidate test case data entity in the executable test case subset that is associated with an automated testing workflow data entity:
identifying an ordered sequence of automated testing workflow steps for the automated testing workflow data entity;
executing a required number of workflow playback operations based at least in part on the ordered sequence, wherein:
each workflow playback operation is associated with an automated testing workflow step in the ordered sequence,
the required number of workflow playback operations stop with a terminal workflow playback operation that is associated with a target automated testing workflow step that is a first automated testing workflow step with a negative success indicator, and
executing a workflow playback operation comprises: (i) identifying a workflow simulation web environment for a webpage associated with the automated testing workflow step for the workflow playback operation; (ii) generating a modified web environment state for the automated testing workflow step by modifying a web environment state of the workflow simulation web environment based at least in part on a captured user interaction for the automated testing workflow step; and (iii) generating the success indicator for the workflow playback operation based at least in part on the modified web environment state for the automated testing workflow step;
generating the execution log based at least in part on the modified web environment state for the target automated testing workflow step; and
providing access to the execution log using a workflow visualization playback user interface, wherein the workflow playback visualization user interface is configured to: (i) display the execution log; and (ii) enable modifying the target automated testing workflow step.

7. The computer-implemented method of claim 1, wherein enabling the end user to perform one or more software testing operations based at least in part on the execution run data entity comprises:
in response to determining that the execution run automation parameter describes that the execution run data entity has a manual execution run automation type:
enabling the end user to modify the execution run data entity by defining each manual test case result indicator for at least one candidate test case data entity in the executable test case subset.

8. The computer-implemented method of claim 7, wherein enabling the end user to perform one or more software testing operations based at least in part on the execution run data entity comprises:
in response to determining that the execution run automation parameter describes that the execution run data entity has the manual execution run automation type:
enabling the end user to modify the execution run data entity by defining each manual test case step result indicator for at least one test case step in a set of test case steps for the executable test case subset.

9. The computer-implemented method of claim 1, wherein enabling the end user to perform one or more software testing operations based at least in part on the execution run data entity comprises:
in response to determining that the execution run automation parameter describes that the execution run data entity has a manual execution run automation type:
for each candidate test case data entity in the executable test case subset, generating a session data entity and providing access to the session data entity as part of test verification data for the execution run data entity.

10. An apparatus for generating an execution run data entity based at least in part on an execution plan data entity, the apparatus comprising at least one processor and at least one memory including program code, the at least one memory and the program code configured to, with the processor, cause the apparatus to at least:
identify a set of execution run definition parameters for the execution run data entity, wherein the set of execution run definition parameters comprise an execution run automation parameter for the execution run data entity;
generate an executable test case subset of a set of candidate test case data entities for the execution run data entity, wherein the executable test case subset for the execution run data entity is determined by filtering a planned test case subset for the execution plan data entity based at least in part on the execution run automation parameter and a skipped test case list for the execution run data entity;
generate the execution run data entity based at least in part on the executable test case subset and the set of execution run definition parameters; and
enable an end user to perform one or more software testing operations based at least in part on the execution run data entity.

11. The apparatus of claim 10, wherein generating the executable test case subset comprises:
in response to determining that the execution run automation parameter describes that the execution run data entity has an automated execution run automation type:
generating an automatable test case subset of the planned test case subset, wherein each candidate test case data entity in the automatable test case subset is associated with an automated testing workflow data entity, and
filtering the automatable test case subset based at least in part on the skipped test case list to generate the executable test case subset.

12. The apparatus of claim 10, wherein generating the executable test case subset comprises:
in response to determining that the execution run automation parameter describes that the execution run data entity has a manual execution run automation type:
filtering the planned test case subset based at least in part on the skipped test case list to generate the executable test case subset.

13. The apparatus of claim 10, wherein enabling the end user to perform one or more software testing operations based at least in part on the execution run data entity comprises:
in response to determining that the execution run automation parameter describes that the execution run data entity has an automated execution run automation type:
enabling the end user to cause a testing computing entity to execute the execution run data entity.

14. The apparatus of claim 13, wherein:
the set of execution run definition parameters comprise an execution run serial execution parameter, an execution run parallelization parameter for the execution run data entity, an execution run scheduling parameter for the execution run data entity, and an execution run web environment parameter for the execution run data entity, and
enabling the end user to cause the testing computing entity to execute the execution run data entity comprises enabling the end user to cause the testing computing entity to execute the execution run data entity in accordance with the execution run parallelization parameter, the execution run scheduling parameter, and the execution run web environment.

15. The apparatus of claim 13, wherein executing the execution run data entity comprises:
for each candidate test case data entity in the executable test case subset that is associated with an automated testing workflow data entity:
identifying an ordered sequence of automated testing workflow steps for the automated testing workflow data entity;
executing a required number of workflow playback operations based at least in part on the ordered sequence, wherein:
each workflow playback operation is associated with an automated testing workflow step in the ordered sequence,
the required number of workflow playback operations stop with a terminal workflow playback operation that is associated with a target automated testing workflow step that is a first automated testing workflow step with a negative success indicator, and
executing a workflow playback operation comprises: (i) identifying a workflow simulation web environment for a webpage associated with the automated testing workflow step for the workflow playback operation; (ii) generating a modified web environment state for the automated testing workflow step by modifying a web environment state of the workflow simulation web environment based at least in part on a captured user interaction for the automated testing workflow step; and (iii) generating the success indicator for the workflow playback operation based at least in part on the modified web environment state for the automated testing workflow step;
generating the execution log based at least in part on the modified web environment state for the target automated testing workflow step; and
providing access to the execution log using a workflow visualization playback user interface, wherein the workflow playback visualization user interface is configured to: (i) display the execution log; and (ii) enable modifying the target automated testing workflow step.

16. The apparatus of claim 10, wherein enabling the end user to perform one or more software testing operations based at least in part on the execution run data entity comprises:
in response to determining that the execution run automation parameter describes that the execution run data entity has a manual execution run automation type:
enabling the end user to modify the execution run data entity by defining each manual test case result indicator for at least one candidate test case data entity in the executable test case subset.

17. The apparatus of claim 16, wherein enabling the end user to perform one or more software testing operations based at least in part on the execution run data entity comprises:
in response to determining that the execution run automation parameter describes that the execution run data entity has the manual execution run automation type:
enabling the end user to modify the execution run data entity by defining each manual test case step result indicator for at least one test case step in a set of test case steps for the executable test case subset.

18. The apparatus of claim 10, wherein enabling the end user to perform one or more software testing operations based at least in part on the execution run data entity comprises:
in response to determining that the execution run automation parameter describes that the execution run data entity has a manual execution run automation type:
for each candidate test case data entity in the executable test case subset, generating a session data entity and providing access to the session data entity as part of test verification data for the execution run data entity.

19. A computer program product for generating an execution run data entity based at least in part on an execution plan data entity, the computer program product comprising at least one non-transitory computer-readable storage medium having computer-readable program code portions stored therein, the computer-readable program code portions configured to:
identify a set of execution run definition parameters for the execution run data entity, wherein the set of execution run definition parameters comprise an execution run automation parameter for the execution run data entity;
generate an executable test case subset of a set of candidate test case data entities for the execution run data entity, wherein the executable test case subset for the execution run data entity is determined by filtering a planned test case subset for the execution plan data entity based at least in part on the execution run automation parameter and a skipped test case list for the execution run data entity;
generate the execution run data entity based at least in part on the executable test case subset and the set of execution run definition parameters; and
enable an end user to perform one or more software testing operations based at least in part on the execution run data entity.

20. The computer program product of claim 19, wherein generating the executable test case subset comprises:
in response to determining that the execution run automation parameter describes that the execution run data entity has an automated execution run automation type:
generating an automatable test case subset of the planned test case subset, wherein each candidate test case data entity in the automatable test case subset is associated with an automated testing workflow data entity, and
filtering the automatable test case subset based at least in part on the skipped test case list to generate the executable test case subset.
